(19) United States
(12) Patent Application Publication
(10) Pub. No.: US 2025/0031227 A1
(43) Pub. Date: Jan. 23, 2025

(54) TECHNIQUES FOR UAV-TO-EVERYTHING SUBSCRIPTION MANAGEMENT

(71) Applicant: QUALCOMM Incorporated, San Diego, CA (US)

(72) Inventors: Kefeng ZHANG, Beijing (CN); Stefano FACCIN, San Ysidro, CA (US); Drew Foster VAN DUREN, Templeton, CA (US)

(21) Appl. No.: 18/716,467

(22) PCT Filed: Feb. 16, 2022
(86) PCT No.: PCT/CN2022/076433

§ 371 Date: Jun. 4, 2024

(51) Int. Cl. H04W 72/40; H04W 8/18; H04W 92/18

(52) U.S. Cl. CPC H04W 72/40; H04W 8/18; H04W 92/18

(57) ABSTRACT

Methods, systems, and devices for wireless communications are described. Specifically, techniques for performing unmanned aerial vehicle (UAV)-to-everything (U2X) registration procedures and well as techniques for updating U2X subscription data within the network are described. A user equipment (UE) may transmit, as part of a registration procedure between the UE and a network, capability signaling indicating a UAV-related category associated with the UE and a capability for the UE to perform sidelink communications to support UAV services. The UE may receive, as part of the registration procedure and based on the capability signaling, a registration acceptance message in accordance with a subscription associated with the UE. The UE may then communicate a sidelink message associated with the UAV services in accordance with the capability to support the UAV services and the subscription associated with the UE.

### CROSS REFERENCE

The present Application is a 371 national phase filing of International PCT Application No. PCT/CN2022/076433 by ZHANG et al., entitled “TECHNIQUES FOR UAV-TO-EVERYTHING SUBSCRIPTION MANAGEMENT,” filed Feb. 16, 2022, which is assigned to the assignee hereof, and which is expressly incorporated by reference in its entirety herein.

### FIELD OF TECHNOLOGY

The following relates to wireless communications, including techniques for unmanned aerial vehicle (UAV)-to-everything (U2X) subscription management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications support communications between wireless devices (e.g., UEs), which are referred to as sidelink communications. For example, some wireless communications systems may support unmanned aerial vehicle (UAV) communications, in which UEs associated with UAVs can communicate with other wireless devices, including infrastructure units to provide guidance, support, and control to the UAVs.

### SUMMARY

The described techniques relate to improved methods, systems, devices, and apparatuses that support techniques for subscription management for unmanned aerial vehicles (UAVs) in a wireless communications system, such as a cellular network that supports UAV-to-everything (U2X) communications and services. Generally, aspects of the present disclosure support signaling and parameters for handling U2X subscription information. In particular, aspects of the present disclosure support techniques for performing U2X registration procedures between user equipments (UEs) and the network, as well as techniques for updating U2X subscription data within the network. In some implementations, UEs (e.g., UAVs) transmit capability signaling to the network, where the capability signaling indicates a UAV-related category associated with the UE, and what types of UAV services the can support. In such cases, the network updates a U2X subscription based on the capability signaling, and may transmit a registration acceptance message to the UE, where the registration acceptance message authorizes the UE to perform one or more of the supported UAV services. Similarly, the network may revoke the UE's authorization to perform the UAV services at any point. In some cases, the UE may indicate aggregate maximum bit rates (AMBRs), supported bandwidth parts (BWPs), and/or supported radio access technologies (RATs) as part of the capability signaling, which may be updated for the UE's U2X subscription with the network.

A method for wireless communication at a UE is described. The method may include transmitting, as part of a registration procedure between the UE and a network, capability signaling indicating a UAV-related category associated with the UE and a capability for the UE to perform sidelink communications to support one or more UAV services, receiving, as part of the registration procedure and based on the capability signaling, a registration acceptance message in accordance with a subscription associated with the UE, and communicating a sidelink message associated with the one or more UAV services in accordance with the capability of the UE to perform sidelink communications to support the one or more UAV services and the subscription associated with the UE.

An apparatus for wireless communication at a UE is described. The apparatus may include a processor, memory coupled with the processor, and instructions stored in the memory. The instructions may be executable by the processor to cause the apparatus to transmit, as part of a registration procedure between the UE and a network, capability signaling indicating a UAV-related category associated with the UE and a capability for the UE to perform sidelink communications to support one or more UAV services, receive, as part of the registration procedure and based on the capability signaling, a registration acceptance message in accordance with a subscription associated with the UE, and communicate a sidelink message associated with the one or more UAV services in accordance with the capability of the UE to perform sidelink communications to support the one or more UAV services and the subscription associated with the UE.

Another apparatus for wireless communication at a UE is described. The apparatus may include means for transmitting, as part of a registration procedure between the UE and a network, capability signaling indicating a UAV-related category associated with the UE and a capability for the UE to perform sidelink communications to support one or more UAV services, means for receiving, as part of the registration procedure and based on the capability signaling, a registration acceptance message in accordance with a subscription associated with the UE, and means for communicating a sidelink message associated with the one or more UAV services in accordance with the capability of the UE to perform sidelink communications to support the one or more UAV services and the subscription associated with the UE.

A non-transitory computer-readable medium storing code for wireless communication at a UE is described. The code may include instructions executable by a processor to transmit, as part of a registration procedure between the UE and a network, capability signaling indicating a UAV-related category associated with the UE and a capability for the UE to perform sidelink communications to support one or more UAV services, receive, as part of the registration procedure and based on the capability signaling, a registration acceptance message in accordance with a subscription associated with the UE, and communicate a sidelink message associated with the one or more UAV services in accordance with the capability of the UE to perform sidelink communications to support the one or more UAV services and the subscription associated with the UE.

Some examples of the method, apparatuses, and non-transitory computer-readable medium described herein may further include operations, features, means, or instructions for transmitting, via the capability signaling, an indication of an AMBR, a supported radio access technology (RAT), or both, associated with the capability to perform sidelink communications to support the one or more UAV services, where the sidelink message may be communicated in accordance with the AMBR, the supported RAT, or both.

Some examples of the method, apparatuses, and non-transitory computer-readable medium described herein may further include operations, features, means, or instructions for transmitting, via the capability signaling, an indication of a first AMBR associated with a first RAT and a second AMBR associated with a second RAT, where the sidelink message may be communicated in accordance with the first AMBR and the first RAT or in accordance with the second AMBR and the second RAT, where the first RAT includes a 4G RAT, an LTE RAT, or both, and where the second RAT includes a 5G RAT, an NR RAT, or both.

Some examples of the method, apparatuses, and non-transitory computer-readable medium described herein may further include operations, features, means, or instructions for transmitting, via the capability signaling, an indication of a BWP associated with the capability to perform sidelink communications to support the one or more UAV services, where the sidelink message may be communicated within the BWP.

Some examples of the method, apparatuses, and non-transitory computer-readable medium described herein may further include operations, features, means, or instructions for receiving control signaling indicating a set of multiple UAV services supported by the network, the set of multiple UAV services including the one or more UAV services, where transmitting the capability signaling may be based on receiving the control signaling.

Some examples of the method, apparatuses, and non-transitory computer-readable medium described herein may further include operations, features, means, or instructions for receiving, via the registration acceptance message, an authorization for the UE to perform the sidelink communications to support the one or more UAV services, where communicating the sidelink message may be based on the authorization.

Some examples of the method, apparatuses, and non-transitory computer-readable medium described herein may further include operations, features, means, or instructions for receiving control signaling indicating a revocation of the authorization for the UE to perform the sidelink communications to support the one or more UAV services and refraining from performing the sidelink communications to support the one or more UAV services based on the revocation.

In some examples of the method, apparatuses, and non-transitory computer-readable medium described herein, the UAV-related category includes a UAV-controller (UAV-C) category, an authority UE, a stationary UE, or any combination thereof.

In some examples of the method, apparatuses, and non-transitory computer-readable medium described herein, one or more UAV services include one or more U2X communications services.

A method for wireless communication is described. The method may include receiving, from a UE as part of a registration procedure between the UE and a network, capability signaling indicating a UAV-related category associated with the UE and a capability for the UE to perform sidelink communications to support one or more UAV services, receiving, as part of the registration procedure and based on the capability signaling, subscription data associated with the UE, where the subscription data indicates an authorization for the UE to perform the sidelink communications to support the one or more UAV services, and transmitting a registration acceptance message to the UE as part of the registration procedure and based on the subscription data, receiving the capability signaling, or both.

An apparatus for wireless communication is described. The apparatus may include a processor, memory coupled with the processor, and instructions stored in the memory. The instructions may be executable by the processor to cause the apparatus to receive, from a UE as part of a registration procedure between the UE and a network, capability signaling indicating a UAV-related category associated with the UE and a capability for the UE to perform sidelink communications to support one or more UAV services, receive, as part of the registration procedure and based on the capability signaling, subscription data associated with the UE, where the subscription data indicates an authorization for the UE to perform the sidelink communications to support the one or more UAV services, and transmit a registration acceptance message to the UE as part of the registration procedure and based on the subscription data, receiving the capability signaling, or both.

Another apparatus for wireless communication is described. The apparatus may include means for receiving, from a UE as part of a registration procedure between the UE and a network, capability signaling indicating a UAV-related category associated with the UE and a capability for the UE to perform sidelink communications to support one or more UAV services, means for receiving, as part of the registration procedure and based on the capability signaling, subscription data associated with the UE, where the subscription data indicates an authorization for the UE to perform the sidelink communications to support the one or more UAV services, and means for transmitting a registration acceptance message to the UE as part of the registration procedure and based on the subscription data, receiving the capability signaling, or both.

A non-transitory computer-readable medium storing code for wireless communication is described. The code may include instructions executable by a processor to receive, from a UE as part of a registration procedure between the UE and a network, capability signaling indicating a UAV-related category associated with the UE and a capability for the UE to perform sidelink communications to support one or more UAV services, receive, as part of the registration procedure and based on the capability signaling, subscription data associated with the UE, where the subscription data indicates an authorization for the UE to perform the sidelink communications to support the one or more UAV services, and transmit a registration acceptance message to the UE as part of the registration procedure and based on the subscription data, receiving the capability signaling, or both.

In some examples of the method, apparatuses, and non-transitory computer-readable medium described herein, receiving the subscription data may include operations, features, means, or instructions for retrieving the subscription data from a unified data management repository associated with the network.

In some examples of the method, apparatuses, and non-transitory computer-readable medium described herein, the subscription data associated with the UE includes U2X subscription data.

In some examples of the method, apparatuses, and non-transitory computer-readable medium described herein, the U2X subscription data may be associated with a subscription permanent identifier (SUPI) associated with the UE.

Some examples of the method, apparatuses, and non-transitory computer-readable medium described herein may further include operations, features, means, or instructions for updating a UE context associated with the UE based on receiving the subscription data, where transmitting the registration acceptance message may be based on updating the UE context.

Some examples of the method, apparatuses, and non-transitory computer-readable medium described herein may further include operations, features, means, or instructions for receiving, via the capability signaling, an indication of an AMBR, a supported RAT, or both, associated with the capability to perform sidelink communications to support the one or more UAV services, where receiving the subscription data, transmitting the registration acceptance message, or both, may be based on the AMBR, the supported RAT, or both.

Some examples of the method, apparatuses, and non-transitory computer-readable medium described herein may further include operations, features, means, or instructions for receiving, via the capability signaling, an indication of a first AMBR associated with a first RAT and a second AMBR associated with a second RAT, where receiving the subscription data, transmitting the registration acceptance message, or both, may be based on the first AMBR and the first RAT, the second AMBR and the second RAT, or both, where the first RAT includes a 4G RAT, an LTE RAT, or both, and where the second RAT includes a 5G RAT, an NR RAT, or both.

Some examples of the method, apparatuses, and non-transitory computer-readable medium described herein may further include operations, features, means, or instructions for receiving, via the capability signaling, an indication of a BWP associated with the capability to perform sidelink communications to support the one or more UAV services, where receiving the subscription data, transmitting the registration acceptance message, or both, may be based on the BWP.

Some examples of the method, apparatuses, and non-transitory computer-readable medium described herein may further include operations, features, means, or instructions for transmitting control signaling indicating a set of multiple UAV services supported by the network, the set of multiple UAV services including the one or more UAV services, where receiving the capability signaling may be based on transmitting the control signaling.

Some examples of the method, apparatuses, and non-transitory computer-readable medium described herein may further include operations, features, means, or instructions for transmitting, via the registration acceptance message and based on the subscription data, an indication of the authorization for the UE to perform the sidelink communications to support the one or more UAV services.

Some examples of the method, apparatuses, and non-transitory computer-readable medium described herein may further include operations, features, means, or instructions for transmitting control signaling indicating a revocation of the authorization for the UE to perform the sidelink communications to support the one or more UAV services.

In some examples of the method, apparatuses, and non-transitory computer-readable medium described herein, the UAV-related category includes a UAV-C category, an authority UE, a stationary UE, or any combination thereof.

In some examples of the method, apparatuses, and non-transitory computer-readable medium described herein, one or more UAV services include one or more U2X communications services.

### BRIEF DESCRIPTION OF THE DRAWINGS

FIG. 1 illustrates an example of a wireless communications system that supports techniques for unmanned aerial vehicle (UAV)-to-everything (U2X) subscription management in accordance with one or more aspects of the present disclosure.

FIG. 2 illustrates an example of a wireless communications system that supports techniques for U2X subscription management in accordance with one or more aspects of the present disclosure.

FIG. 3 illustrates an example of a wireless communications system that supports techniques for U2X subscription management in accordance with one or more aspects of the present disclosure.

FIG. 4 illustrates an example of a process flow that supports techniques for U2X subscription management in accordance with one or more aspects of the present disclosure.

FIGS. 5 and 6 show block diagrams of devices that support techniques for U2X subscription management in accordance with one or more aspects of the present disclosure.

FIG. 7 shows a block diagram of a communications manager that supports techniques for U2X subscription management in accordance with one or more aspects of the present disclosure.

FIG. 8 shows a diagram of a system including a device that supports techniques for U2X subscription management in accordance with one or more aspects of the present disclosure.

FIGS. 9 and 10 show block diagrams of devices that support techniques for U2X subscription management in accordance with one or more aspects of the present disclosure.

FIG. 11 shows a block diagram of a communications manager that supports techniques for U2X subscription management in accordance with one or more aspects of the present disclosure.

FIG. 12 shows a diagram of a system including a device that supports techniques for U2X subscription management in accordance with one or more aspects of the present disclosure.

FIGS. 13 through 16 show flowcharts illustrating methods that support techniques for U2X subscription management in accordance with one or more aspects of the present disclosure.

### DETAILED DESCRIPTION

Some wireless communications support communications between wireless devices (e.g., user equipments (UEs)), which are referred to as sidelink communications. For example, some wireless communications systems support vehicle-to-everything (V2X) communications, in which vehicles (e.g., UEs) in a system can communicate with other wireless devices, including roadside infrastructure such as roadside units. The network may maintain a user profile associated with each wireless device in a unified data management (UDM) repository, where the user profile includes subscription information which authorizes the respective wireless device to perform certain V2X services. However, some wireless communications systems may also support unmanned aerial vehicles (UAVs) which support UAV services, and subscription information for V2X is may not apply to U2X services due to the different requirements of the service types, applications, policy and quality of service (QOS) requirements, and radio parameters. As such, conventional registration and subscription update techniques used for V2X services may not apply to U2X services, and separate information/registration techniques may be defined for U2X services.

Accordingly, aspects of the present disclosure are directed to signaling and parameters for handling U2X subscription information. In particular, aspects of the present disclosure are directed to techniques for performing U2X registration procedures between UEs (e.g., UAVs) and the network, as well as techniques for updating U2X subscription data within the network. In some implementations, UEs (e.g., UAVs) transmit capability signaling to the network, where the capability signaling indicates a UAV category associated with the UE, and what types of UAV services the can support. In such cases, the network updates a U2X subscription based on the capability signaling, and may transmit a registration acceptance message to the UE, where the registration acceptance message authorizes the UE to perform one or more of the supported UAV services. Similarly, the network may revoke the UE's authorization to perform the UAV services at any point. In some cases, the UE can indicate aggregate maximum bit rates (AMBRs), supported bandwidth parts (BWPs), and/or supported radio access technologies (RATs) as part of the capability signaling, which may be updated for the UE's U2X subscription with the network.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for U2X subscription management.

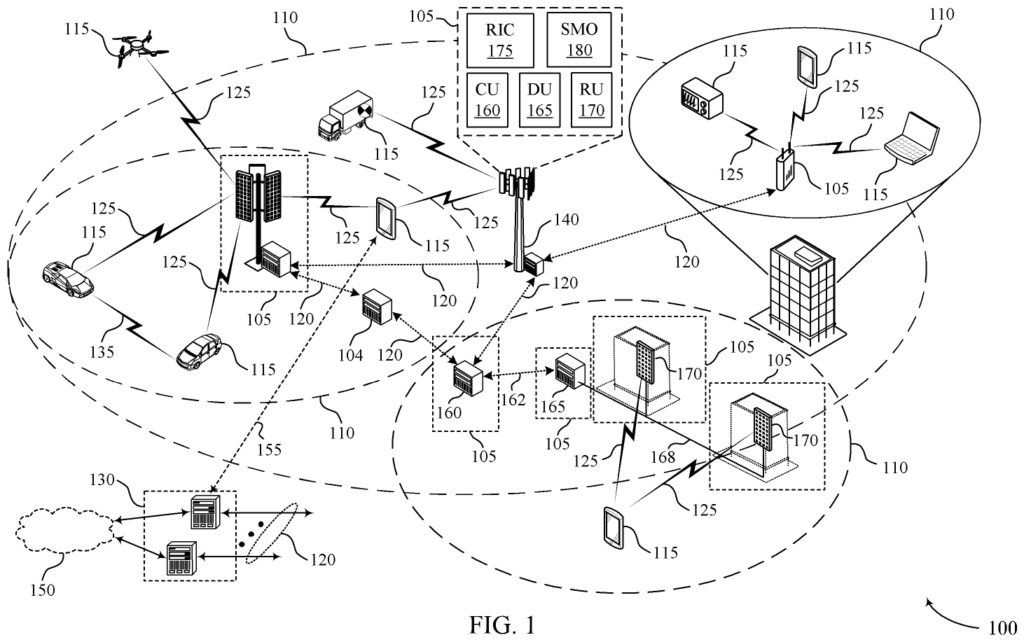

FIG. 1 illustrates an example of a wireless communications system 100 that supports techniques for U2X subscription management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In some examples, network entities 105 and UEs 115 may wirelessly communicate via one or more communication links 125. For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 (e.g., a base station 140) may be implemented in an aggregated or monolithic base station architecture, or alternatively, in a disaggregated base station architecture. For example, a network entity 105 may include one or more of a central unit (CU) 160, a distributed unit (DU) 165, a radio unit (RU) 170, a Radio Access Network (RAN) Intelligent Controller (RIC) 175 (e.g., a Near-Real Time RIC (Near-RT RIC), a Non-Real Time RIC (Non-RT RIC), a Service Management and Orchestration (SMO) 180 system, or any combination thereof. An RU 170 may also be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations.

The split of functionality between a CU 160, a DU 165, and an RU 175 is flexible and may support different functionalities depending upon which functions (e.g., network layer functions, protocol layer functions, baseband functions, radio frequency functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an integrated access backhaul (IAB) network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 (e.g., one or more RUs 170) may be partially controlled by CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for U2X subscription management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 170, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (RAT) (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) RAT, or NR technology in an unlicensed band such as the 5 GHz industrial, scientific, and medical (ISM) band. While operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some aspects, the UEs 115 and the network entities 105 (e.g., components of base stations) of the wireless communications system 100 may support signaling and parameters for handling U2X subscription information. In particular, aspects of the present disclosure are directed to techniques for performing U2X registration procedures between UEs 115 (e.g., UAVs) and the network, as well as techniques for updating U2X subscription data within the network.

For example, a UE 115 (e.g., UAV) of the wireless communications system 100 may transmit capability signaling to the network, where the capability signaling indicates a UAV category associated with the UE 115, and what types of UAV services the can support. In such cases, the network may update a U2X subscription based on the capability signaling, and may transmit a registration acceptance message to the UE 115, where the registration acceptance message authorizes the UE 115 to perform one or more of the supported UAV services. Similarly, the network may revoke the UE's authorization to perform the UAV services at any point. In some cases, the UE 115 may indicate AMBRs, supported BWPs, and/or supported RATs as part of the capability signaling, which may be updated for the UE's U2X subscription with the network.

Techniques described herein may enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

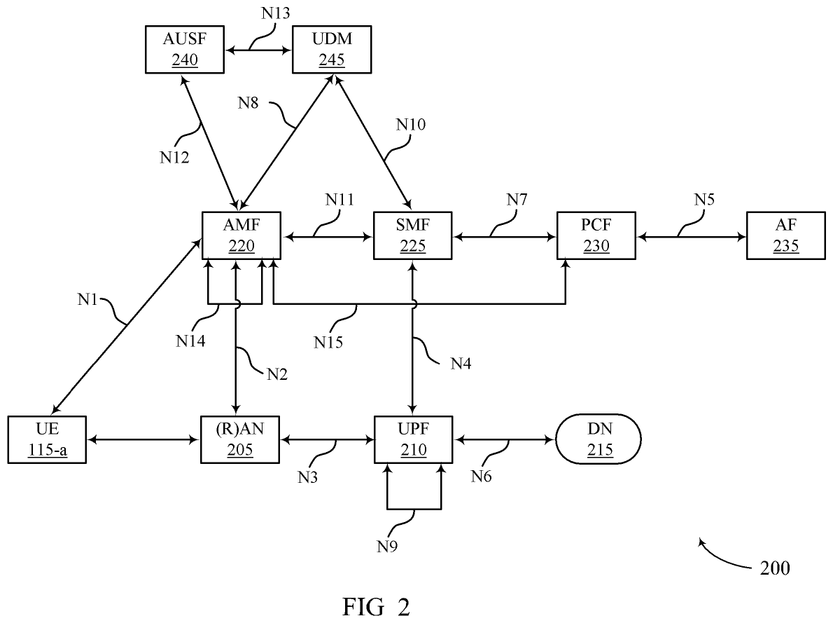

FIG. 2 illustrates an example of a wireless communications system 200 that supports techniques for U2X subscription management in accordance with one or more aspects of the present disclosure. In some examples, wireless communications system 200 may implement, or be implemented by, aspects of wireless communications system 100. In particular, wireless communications system 200 illustrates a 5G system architecture for network access in a non-roaming context.

The wireless communications system 200 may include a UE 115-a, a radio access network (RAN) 205, a user plane function (UPF) 210, a data network (DN) 215, an access and mobility management function (AMF) 220, a session management function (SMF) 225, a policy management function (PCF) 230, an application function (AF) 235, an authentication server function (AUSF) 240, and a unified data management (UDM) 245. Each of the respective components of the wireless communications system 200 may be communicatively coupled to one another via one or more communication links or interfaces. For example, as shown in FIG. 2, the UE 115-a may be communicatively coupled to the AMF 220 via an NI interface. Similarly, the AMF 220 may be communicatively coupled to the UDM 245 via an N8 interface.

Each of the respective components of the wireless communications system 200 may serve different functions or purposes. In some aspects the RAN 205 may be an example of a network entity 105 such as one or more components of a base station. In this regard, the RAN 205 may include a radio unit (RU), a distributed unit (DU), a central unit (CU), or any combination thereof, where the respective components of the RAN 205 may be co-located, disaggregated, etc. The UPF 210 may be responsible for data packet and forwarding, and may include a function that connects data over the RAN 205 to the internet. The DN 215 may identify service provider services, internet access, and third party services. The AMF 220 is a control plane function which is configured to receive connection and session-related information from the UE 115-a (e.g., via N1 and/or N2 interfaces), and handle connection and mobility management tasks. The SMF 225 is a control plane function configured to update and remove protocol data unit (PDU) sessions, and manage session context with a user plane function (UPF). The PCF 230 manages policies within the wireless communications system 200, and enables operators to efficiently create and deploy policies within the network.

The AF 235 supports application traffic routing, and performs operations such as accessing network exposure function for retrieving resources, interacting with the PCF 230 for policy control, exposing services to end users, and the like. The AUSF 240 performs authentication functions with UEs 115 (E.g., UE 115-a) within the wireless communications system 200. Lastly, the UDM 245 may include a repository to store and control user data within the wireless communications system 200. For example, the UDM 245 may store subscription information associated with UEs 115 (e.g., UE 115-a) within the wireless communications system 200.

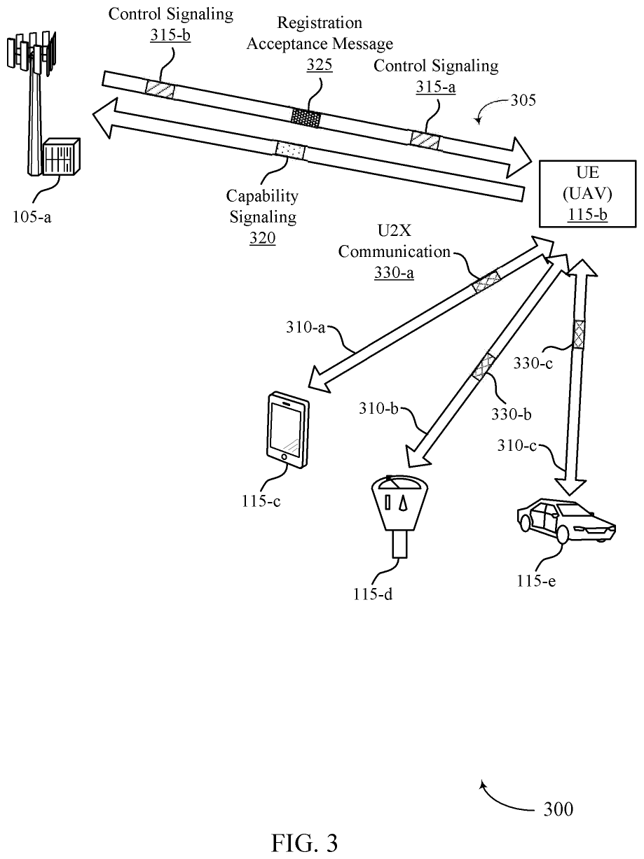

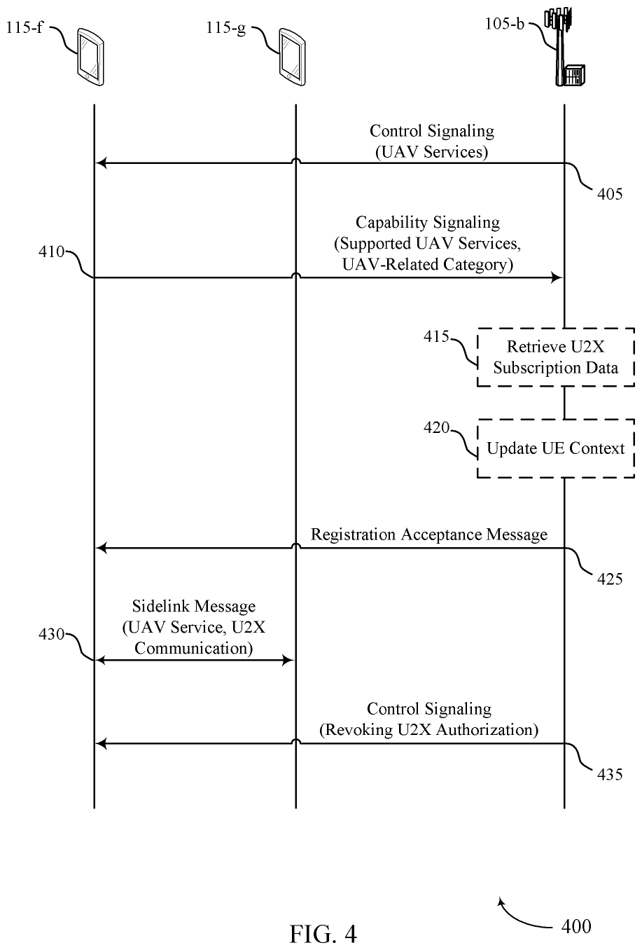

Respective components of the wireless communications system 200 may support registration procedures between the UE 115-a and the network (e.g., various components of the network illustrated in FIG. 2) which enable the UE 115-a to be configured with U2X parameters for U2X services. Signaling between the UE 115-a and the respective components of the wireless communications system 200 used to perform U2X registration procedures may be further shown and described with reference to FIGS. 3 and 4.

FIG. 3 illustrates an example of a wireless communications system 300 that supports techniques for U2X subscription management in accordance with one or more aspects of the present disclosure. In some examples, wireless communications system 200 may implement, or be implemented by, aspects of wireless communications system 100, wireless communications system 200, or both. In particular, wireless communications system 300 may support signaling used to perform U2X registration procedures and U2X registration update procedures between a UE 115-b and the network. In this regard, the wireless communication system 300 may support signaling and configurations which enable the UE 115-b to indicate a capability to perform U2X services, receive parameters and policy configurations for U2X services, and perform sidelink communications for U2X services.

The wireless communications system 300 may include a network entity 105-a (e.g., one or more components of base station), a first UE 115-b, a second UE 115-c, a third UE 115-d, and a fourth UE 115-e, which may be examples network entities 105, UEs 115, and other wireless as described with reference to FIG. 1. For example, as shown in FIG. 3, the first UE 115-b may include an example of a UAV, where the third UE 115-d and the fourth UE 115-e may include examples of a wireless roadside unit and a vehicle, respectively.

The first UE 115-b may communicate with the network entity 105-a using a communication link 305, which may be an example of an NR or LTE link between the first UE 115-b and the network entity 105-a. In some cases, the communication link 305 between the first UE 115-b and the network entity 105-a may include an example of an access link (e.g., Uu link) which may include a bi-directional link that enables both uplink and downlink communication. For example, the first UE 115-b may transmit uplink signals, such as uplink control signals or uplink data signals (e.g., SRSs), to the network entity 105-a using the communication link 305, and the network entity 105-a may transmit downlink signals, such as downlink control signals or downlink data signals, to the first UE 115-b using the communication link 305. Additionally, or alternatively, the second UE 115-c, the third UE 115-d, the fourth UE 115-e, or any combination thereof, may include communication links (e.g., Uu links) to facilitate wireless communications between the network entity 105-a and the respective UEs 115-c, 115-d, 115-e. Moreover, in some aspects, the first UE 115-b may communicate with the second UE 115-c, the third UE 115-d, and the fourth UE 115-e via a communication links 310-a, 310-b, and 310-c. The communication links 310 between the respective UEs 115 may include examples of sidelink communication links or PC5 links.

As noted previously herein, some wireless communications systems may be configured to support V2X) communications, in which vehicles (e.g., UEs) in a system can communicate with other wireless devices, including roadside infrastructure such as roadside units. For example, in some implementations, the first UE 115-b of the wireless communications system 300 may support V2X communications.

A V2X application may include any application using one or more V2X services, such as an active safety application in a vehicle, using V2X services such as emergency warning and vehicle to vehicle safety and awareness. A V2X application may operate towards a V2X Application Server. In general, the term “V2X communication” may refer to a communication to support V2X services leveraging Uu and/or PC5 reference points. V2X services are realized by various types of V2X applications, including Vehicle-to-Vehicle (V2V), Vehicle-to-Pedestrian (V2P), Vehicle-to-Infrastructure (V2I) and Vehicle-to-Network (V2N). The term “V2X message” refers to a dedicated messaging type of V2X service, for example ITS messages. Moreover, V2X service may include a data service offered to V2X applications and optionally V2X Application Servers. A V2X service belongs to one V2X service type, and may include a message or other data delivery. A V2X service can be associated with one or more V2X applications, and a V2X application can be associated with one or more V2X services. V2X service types may be identified by an ITS application identifier (ITS-AID), a provider service identifier (PSID), an application identifier (AID), or any combination thereof.

Some wireless communications systems may also include UAVs which support UAV services. For example, as shown in FIG. 3, the first UE 115-b may include an example of a UAV in some cases. U2X communications may include sidelink communications (e.g., communications between the UEs 115) to support U2X services by leveraging Uu and/or PC5 reference points. U2X services are realized by various types of U2X applications, including UAV-to-UAV (U2U), UAV-to-Pilot (U2P), UAV-to-Infrastructure (U2I), UAV-to-Network (U2N), and urban air mobility (UAM). As it is used herein, the term U2X message may refer to a dedicated messaging type of U2X service (e.g., BRID messages). Moreover, the term “U2X service” may refer to a data service offered to U2X applications and optionally U2X Application Servers. A U2X service belongs to one U2X service type. It may include message or other data delivery. A U2X service can be associated with one or more U2X applications, and a U2X application can be associated with one or more U2X services. One example of a U2X service may include “detect and avoid (DAA),” in which a UE 115 may surveil traffic and remain a safe distance from nearby aircraft (e.g., cooperative aircraft and non-cooperative aircraft) so as not to create a collision hazard.

In the context of U2X communications over PC5 interface, two types of PC5 reference points exist: (1) LTE-based PC5 reference point, and (2) NR-based PC5 reference point. A UE 115 (e.g., first UE 115-b) may use either type of PC5 (or both) for performing U2X communications 330 depending on the services the respective UE 115 supports. The U2X communication over PC5 reference point supports roaming and inter-public land mobile network (PLMN) operations. In some aspects, U2X communication over PC5 reference point may supported in cases where the first UE 115-b is served by NR or E-UTRA, as well the first UE 115-b may support U2X communication over PC5 reference point whether or not the first UE 115-b is connected to a serving network (e.g., whether or not the first UE 115-b includes a SIM card).

Comparatively, in the context of U2X communications over Uu interface, U2X communications 330 via unicast over the Uu reference point may support non-roaming and roaming operations. For transport of V2X messages over Uu reference point the communications mechanisms may be used to establish the suitable PDU sessions, and V2X messages may be routed towards V2X application server or towards UEs 115 with existing unicast routing.

In order to support PC5 based U2X communication, the UEs 115 may be configured with policy and parameters (e.g., RAT type, RF parameters, QoS requirement, serving PLMN) to perform PC5 communication with other devices. That is, the first UE 115-b may be configured with U2X policy and parameters in order to support sidelink communications with the UEs 115-c, 115-d, 115-d for U2X services. Profile information associated with each respective UE 115-b may be stored in the UDM, and may include subscription information to give the respective UEs 115 permission to perform V2X services.

However, parameters and subscription information for V2X does not apply to U2X services due to the different requirements of the service types, applications, application servers, policy and QoS requirements, and radio parameters. As such, parameters for V2X communications services do not apply to U2X services. In this regard, conventional V2X techniques may not be suitable for providing U2X policy and parameters to UEs 115. Moreover, based on conventional V2X techniques, it is unclear what policy and parameters may be provided to UEs 115 to support U2X communications, and how UEs 115 are to use received policy and parameters to perform U2X communications.

Accordingly, the respective devices of the wireless communications system 300 may support signaling and parameters for handling U2X subscription information. In particular, aspects of the present disclosure are directed to techniques for performing U2X registration procedures between the first UE 115-b (e.g., UAVs) and the network, as well as techniques for updating U2X subscription data within the network. As such, techniques described herein are directed to handling U2X subscription information, including registration procedures and subscriber data update notifications.

Moreover, techniques described herein may support transport broadcast remote identification and C2 communications via by implementing architectural and functional modifications to leverage communications mechanisms within the wireless communications system 200 to support aviation applications such as Detect And Avoid (DAA), swarming, and the like. Aspects of the present disclosure may utilize both PC5 and Uu interfaces for U2X communication (e.g., BRID and DAA).

For example, as shown in FIG. 2, the first UE 115-b may receive control signaling 315-a, where the control signaling 315-a indicates a set of UAV services (e.g., U2X communications, U2X services) supported by the network. In other words, the control signaling 315-a may indicate multiple types of U2X communications or U2X services supported by the network.

In some aspects the first UE 115-b may transmit capability signaling 320 as part of a registration procedure (e.g., U2X registration procedure) between the first UE 115-b and the network entity 105-a. In some aspects, the capability signaling 320 may indicate a capability for the first UE 115-b to perform sidelink communications to support one or more UAV services. In other words, the capability signaling 320 may indicate one or more UAV services (e.g., U2X services) that is supports from the set of UAV services indicated via the control signaling 315-a. For example, the capability signaling 320 may include one or more bit field values corresponding to one or more UAV services it is capable of supporting.

In this regard, the first UE 115-b may include the PC5 capability for U2X (e.g., LTE PC5 only, NR PC5 only, both LTE and NR PC5) as part of the “5GMM capability” in a registration request message. As such, the capability signaling 320 illustrated in FIG. 2 may include a part of a registration request message. In some aspects, the AMF may store the capability information for U2X operation. The PC5 Capability for U2X indicates whether the UE is capable of U2X communication over PC5 reference point and which specific PC5 RAT(s) it supports.

Additionally, or alternatively, the capability signaling 320 may indicate a UAV-related category associated with the first UE 115-b. The UAV-related category may include a UAV UE category, a UAV controller (UAV-C) category, an authority UE (e.g., police handset, airport authority UE), a stationary UE (e.g., used by unmanned aircraft system (UAS) service supplier (USS), UAS traffic management (UTM), aeronautical information service provider, weather information service provider, terrain and obstacles service provider, etc.), or any combination thereof. In this regard, the “UAV-related category” may include categories of UAVs, UEs 115, or both. As such, the “UAV-related category” may additionally or alternatively be referred to as a “U2X -UE category.”

In some aspects, the capability signaling 320 may indicate one or more parameters, conditions, or characteristics associated with the performance of U2X communications (e.g., UAV services) at the first UE 115-b. Parameters associated with the performance of U2X communications which may be indicated via the control signaling 315 may include, but are not limited to, applicable AMBR(s), supported RATs, BWPs, and the like.

For example, in some cases, the capability signaling 320 may indicate one or more AMBRs, one or more supported RATs, or both, associated with the capability to perform supported UAV services. In other words, the first UE 115-b may indicate an AMBR for each supported UAV service, and corresponding RAT in which each UAV service may be performed (e.g., UE-PC5-AMBR per PC5 RAT, including UE-PC5-AMBR for LTE PC5 and UE-PC5-AMBR for NR PC5). Additionally, or alternatively, the capability signaling 320 may indicate an AMBR corresponding to respective BWPs usable for U2X communications. For instance, the capability signaling 320 may indicate a first AMBR associated with a first RAT (e.g., 4G, LTE) and a second AMBR associated with a second RAT (e.g., 5G, NR).

Additionally, or alternatively, the capability signaling 320 may indicate one or more BWPs in which U2X communications may be performed. For example, the capability signaling 320 may indicate that the first UE 115-b is capable of performing a first UAV service (e.g., first U2X service) within a first BWP, and a second UAV service (e.g., second U2X service) within a second BWP.

In some aspects, the network entity 105-a may retrieve (receive) subscription data associated with the first UE 115-b. The network entity 105-a may retrieve the subscription data as part of the registration procedure performed between the first UE 115-b and the network entity 105-a. In this regard, the network entity 105-a may retrieve the subscription data (e.g., U2X subscription data) based on transmitting the control signaling 315-a, receiving the capability signaling 320, or both.

In some aspects, subscription data may include information associated with a capability and authorization of the first UE 115-b to perform U2X communications. In this regard, the subscription data may indicate (or be associated with) an authorization for the first UE 115-b to perform the sidelink communications to support the one or more UAV services indicated via the capability signaling 320. The subscription data (e.g., U2X subscription data) may be associated with a subscription permanent identifier (SUPI) associated with the first UE 115-b. The network entity 105-a may retrieve subscription databased on transmitting the control signaling 315-a. For example, as described previously herein, the network entity 105-a may retrieve subscription data associated with the first UE 115-f via a UDM, such as the UDM 245 illustrated in FIG. 2.

In some aspects, the wireless communications system 200 may support multiple different subscription data types (e.g., UE subscription data types). In particular, the wireless communications system 200 may support multiple subscription data types used in the Nudm_SubscriberDataManagement Service. Each respective subscription data type may include one or more fields.

In some aspects, the wireless communications system 200 may support a “U2X subscription data” type. The U2X subscription data type may be associated with an “NR U2X services authorization” field, an “LTE U2X services authorization” field, an “NR UE-PC5-AMBR” field, and an “LTE UE-PC5-AMBR” field. The “NR U2X services authorization” field and the “LTE U2X services authorization” field may indicate whether the respective UE 115 (e.g., first UE 115-b) is authorized to use the NR sidelink or the LTE sidelink, respectively, for U2X services as a UAV-UE, UAV-C UE, authority UE, or stationary UE. Comparatively, the “NR UE-PC5-AMBR” field and the “LTE UE-PC5-AMBR” field are associated with an AMBR of the respective UE's 115 NR or LTE sidelink, respectively, used for U2X communications/services.

Other example subscription data types supported by the wireless communications system may include, but are not limited to, an access and mobility subscription data type (e.g., data for UE 115 registration and mobility management), a slice selection subscription data type (data for slice selection), an SMF selection subscription data type (data for SMF selection), a UE context in SMF data type, an SMS management subscription data type (data used by SMSF for SMSF registration), an SMS subscription data type (data for AMF), a UE context in SMSF data type, a session management subscription data type (data for PDU session establishment), an identifier translation data type, an intersystem continuity context data type, an LCS privacy data type (data for GMLC), an LCS mobile origination data type (data for AMF), a user consent data type, a UE reachability data type, a V2X subscription data type, a ProSe subscription data type, an MBS subscription data type, or any combination thereof.

Subscription data/information associated with UAV services (U2X communications) may include information associated with authorization for the first UE 115-b to perform U2X communications 330 over PC5 reference point (e.g., as UAV UE, UAV-C UE, authority UE, stationary UE), including for LTE PC5 and NR PC5. Moreover, subscription information for U2X communications 330 may include AMBRs associated with the capability of the first UE 115-b to perform U2X communications 330 (e.g., UE-PC5-AMBR per PC5 RAT, including UE-PC5-AMBR for LTE PC5 and UE-PC5-AMBR for NR PC5). In such cases, the network entity 105-a and/or UDM may retrieve such subscription information from the UDR. Moreover, as described previously herein, such subscription information may be provided to the UDM to the AMF during the UE registration procedure using Nudm_SDM service for subscription data type “U2X subscription data.” Further, the AMF may provide such subscription information to the NG-RAN as part of the UE context information. In order to support interworking with EPC, it is assumed that the EPC and the 5GC have access to a common subscriber database, that is HSS in the case of EPC and the UDM in the case of 5G, acting as the master data base for a given user.

The wireless communications system 200 may support multiple UE subscription data type keys, including a “U2X subscription data” key. The U2X subscription data key may be associated with the SUPI corresponding to the respective UE 115 (e.g., first UE 115-b), as described previously herein. In some aspects, a subscription data type key (e.g., “mandatory key)” may be required for each subscription data type to identify the corresponding data. Depending on the use case, it is possible to use one or multiple sub keys to further identify the corresponding data for some subscription data types.

Additionally, or alternatively, the network entity 105-a may update a UE context associated with the first UE 115-b. In particular, the network entity 105-a may update the UE context based on transmitting the control signaling 315-a, receiving the capability signaling 320, retrieving the subscription data associated with the UE 115-b, or any combination thereof. In some aspects, the updated UE context may be transmitted and/or stored at the UDM (e.g., UDM 245 illustrated in FIG. 2).

In the context of Nudr_DM service, the wireless communications system 200 may utilize one or more sets of parameters, including a data set identifier which uniquely identifies the requested set of data within the UDR, and a data subset identifier, which uniquely identifies the data subset within each data set identifier, and data keys, as described previously herein. Subscription data may include subsets which are particularized (e.g., dedicated) for specific procedures such as mobility, session, etc.

Moreover, in the context of Nudr_DM_Subscribe and Nudr_DM_Notify operations, the target of event reporting may be made up of data keys, data sub key, or both. When a data sub key is defined (e.g., defined in a table) but is not present in the Nudr_DM_Subscribe, all values of the data sub key may be targeted. The data set identifier (if present) plus the set of data subset identifier(s) may correspond to a set of event ID(s). An NF service consumer may include an indicator when it invokes Nudr_DM Query/Create/Update service operation to subscribe the changes of the data, and to avoid a separate Nudr_DM_Subscribe service operation. Depending on the use case, it is possible to use a data key and/or one or multiple data sub keys to further identify the corresponding data.

In some implementations, the AMF may determine whether the first UE 115-b is authorized to perform U2X communication 330 over PC5 reference point based on UE's PC5 capability for U2X (e.g., capability signaling 315) and the subscription data related to U2X service authorization information (e.g., “U2X services authorized” indication, UE-PC5-AMBR per PC5 RAT and cross-RAT PC5 control authorization if applicable) received from UDM. The AMF may be configured to store the U2X service authorization information as part of the UE context. In some aspects, the PCF may be configured to provide the PC5 QoS parameters to the AMF, and the AMF may store the PC5 QoS parameters in the UE context. If the first UE 115-b is authorized to use U2X communication (e.g., perform U2X communications 330) over PC5 reference point, the AMF may not initiate the release of the signaling connection after the completion of the registration procedure. The release of the NAS signaling may rely on the decision of NG-RAN.

In some aspects, the procedure of subscriber data update notification to AMF is performed. In such cases, the Nudm_SDM_Notification service operation may include the “U2X services authorized” indication, the UE-PC5-AMBR, the cross-RAT PC5 control authorization, or any combination. The AMF may be configured to update the UE Context with the above U2X subscription data. When the AMF updates UE context stored at NG-RAN, the UE context contains the U2X subscription data.

In some aspects, the first UE 115-b may receive a registration acceptance message 325 from the network entity 105-a. In some aspects, the registration acceptance message 325 may be received as part of the registration procedure (e.g., U2X registration procedure) performed between the first UE 115-b and the network entity 105-a. In this regard, the first UE 115-b may receive (and the network entity 105-a may transmit) the registration acceptance message 325 based on receiving/transmitting the control signaling 315-a, transmitting/receiving the capability signaling 320, retrieving the subscription data, updating the UE context, or any combination thereof.

The registration acceptance message 325 may be transmitted/received in accordance with a subscription associated with the first UE 115-b with the network. In some aspects, the registration acceptance message 325 may include an authorization an authorization for the first UE 115-b to perform the sidelink communications to support the one or more UAV services. In other words, the registration acceptance message 325 may authorize the first UE 115-b to perform the UAV services (e.g., U2X communications, U2X services) indicated via the capability signaling 320.

The first UE 115-b may communicate (e.g., transmit, receive) a sidelink message associated with the one or more supported/authorized UAV services. For example, the first UE 115-b may communicate (e.g., transmit, receive) U2X communications 330-a, 330-b, and 330-c with the respective UEs 115-c, 115-d, 115-e. In particular, the first UE 115-b may communicate the sidelink message(s) (e.g., perform U2X communication(s) 330) for the UAV service in accordance with the capability of the UE first UE 115-b to perform the UAV services and the subscription associated with the first UE 115-b. As such, the first UE 115-b may communicate the sidelink message (e.g., perform the U2X communication(s) 330) for a UAV service based on receiving the control signaling 315-a, transmitting the capability signaling 320, receiving the registration acceptance message 325, or any combination thereof.

For example, in cases where the capability signaling 320 indicates an AMBR or RAT associated with the capability of the first UE 115-b to perform the UAV services, the first UE 115-b may communicate U2X communication(s) 330 in accordance with the indicated AMBR, the indicated RAT, or both. Similarly, in cases where the capability signaling 320 indicates a BWP associated with the capability of the first UE 115-b to perform the UAV services, the first UE 115-b may communicate the sidelink message(s) (e.g., perform the UAV service, perform the U2X communication(s) 330=) within the indicated BWP. Moreover, the first UE 115-b may perform the U2X communications 330 based on receiving an authorization to perform the U2X AV services via the registration acceptance message 325.

At any time, the operator can remove the UE subscription rights for V2X and/or U2X services from user's profile in the UDM, and revoke the user's permission to use U2X services. In other words, the network entity 105-b may be configured to revoke the authorization of the first UE 115-b to perform U2X communications 330 at any time, based on the satisfaction of certain criteria or thresholds, and the like.

For example, as shown in FIG. 2, the first UE 115-b may receive additional control signaling 315-b from the network entity 105-e, where the additional control signaling 315-b indicates a revocation of the authorization for the first UE 115-b to perform the UAV services. In other words, the additional control signaling 315-b may indicate that the first UE 115-b is no longer authorized to perform sidelink messages for the UAV services. As such, in some implementations, the first UE 115-b may refrain from performing UAV services (e.g., refrain from performing U2X communications 330) after receiving the revocation via the additional control signaling 315-b.

Techniques described herein may enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

FIG. 4 illustrates an example of a process flow 400 that supports techniques for U2X subscription management in accordance with one or more aspects of the present disclosure. In some examples, process flow 400 may implement, or be implemented by, aspects of wireless communications system 100, wireless communications system 200, wireless communications system 300, or any combination thereof. For example, the process flow 400 illustrates a first UE 115-f transmitting capability signaling indicating a UAV-related category and a capability of the UE to perform UAV services (e.g., U2X communications), receiving a registration update procedure, and performing U2X services in accordance with a second UE 115-g, as described with reference to FIGS. 1-3.

In some cases, process flow 400 may include a first UE 115-f, a second UE 115-g, and a network entity 105-b (e.g., base station), which may be examples of corresponding devices as described herein. In particular, the first UE 115-f and the second UE 115-g illustrated in FIG. 4 may include examples of the first UE 115-f and the second UE 115-g, respectively, as illustrated in FIG. 2. In some aspects, the first UE 115-f may include a UE 115, UAV, or both, that is configured to perform U2X communications. Similarly, the network entity 105-b illustrated in FIG. 4 may include an example of the network entity 105-a illustrated in FIG. 2.

In some examples, the operations illustrated in process flow 400 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 405, the first UE 115-f may receive control signaling. In some aspects, the control signaling may indicate a set of UAV services (e.g., U2X communications, U2X services) supported by the network. In other words, the control signaling may indicate multiple types of U2X communications or U2X services supported by the network.

At 410, the first UE 115-f may transmit capability signaling as part of a registration procedure (e.g., U2X registration procedure) between the first UE 115-f and the network entity 105-b. In some aspects, the capability signaling may indicate a capability for the first UE 115-f to perform sidelink communications to support one or more UAV services. In other words, the capability signaling may indicate one or more UAV services (e.g., U2X services) that is supports from the set of UAV services indicated via the control signaling at 405. For example, the capability signaling may include one or more bit field values corresponding to one or more UAV services it is capable of supporting.

Additionally, or alternatively, the capability signaling may indicate a UAV-related category associated with the first UE 115-f. The UAV-related category may include a UAV-C category, an authority UE (e.g., police handset, airport authority UE), a stationary UE (e.g., used by USS, UTM), aeronautical information service provider, weather information service provider, terrain and obstacles service provider, etc.), or any combination thereof. In this regard, the “UAV-related category” may include categories of UAVs, UEs 115, or both. As such, the “UAV-related category” may additionally or alternatively be referred to as a “U2X-UE category.”

In some aspects, the capability signaling may indicate one or more parameters, conditions, or characteristics associated with the performance of U2X communications (e.g., UAV services) at the first UE 115-f. Parameters associated with the performance of U2X communications which may be indicated via the control signaling may include, but are not limited to, applicable AMBR(s), supported RATs, BWPs, and the like. For example, in some cases, the capability signaling may indicate one or more AMBRs, one or more supported RATs, or both, associated with the capability to perform supported UAV services. In other words, the first UE 115-f may indicate an AMBR for each supported UAV service, and corresponding RAT in which each UAV service may be performed. Additionally, or alternatively, the capability signaling may indicate an AMBR corresponding to respective BWPs usable for U2X communications. For instance, the capability signaling may indicate a first AMBR associated with a first RAT (e.g., 4G, LTE) and a second AMBR associated with a second RAT (e.g., 5G, NR).

Additionally, or alternatively, the capability signaling may indicate one or more BWPs in which U2X communications may be performed. For example, the capability signaling may indicate that the first UE 115-f is capable of performing a first UAV service (e.g., first U2X service) within a first BWP, and a second UAV service (e.g., second U2X service) within a second BWP.

At 415, the network entity 105-b may retrieve (receive) subscription data associated with the first UE 115-f. The network entity 105-b may retrieve the subscription data as part of the registration procedure performed between the first UE 115-f and the network entity 105-b. In this regard, the network entity 105-b may retrieve the subscription data (e.g., U2X subscription data) at 415 based on transmitting the control signaling at 405, receiving the capability signaling at 410, or both.

In some aspects, subscription data may include information associated with a capability and authorization of the first UE 115-f to perform U2X communications. In this regard, the subscription data may indicate (or be associated with) an authorization for the first UE 115-f to perform the sidelink communications to support the one or more UAV services indicated via the capability signaling. The subscription data (e.g., U2X subscription data) may be associated with a SUPI associated with the first UE 115-f. The network entity 105-b may retrieve subscription databased on transmitting the control signaling at 405. For example, as described previously herein, the network entity 105-b may retrieve subscription data associated with the first UE 115-f via a UDM, such as the UDM 245 illustrated in FIG. 2.

Subscription data/information associated with UAV services (U2X communications) may include information associated with authorization for the first UE 115-f to perform U2X communications over PC5 reference point (e.g., as UAV UE, UAV-C UE, authority UE, stationary UE), including for LTE PC5 and NR PC5. Moreover, subscription information for U2X communications 330 include AMBRs associated with the capability of the first UE 115-f to perform U2X communications.

At 420, the network entity 105-b may update a UE context associated with the first UE 115-f. In particular, the network entity 105-b may update the UE context based on transmitting the control signaling at 405, receiving the capability signaling at 410, retrieving the subscription data at 415, or any combination thereof. In some aspects, the updated UE context may be transmitted and/or stored at the UDM (e.g., UDM 245 illustrated in FIG. 2).

At 425, the first UE 115-f may receive a registration acceptance message from the network entity 105-b. In some aspects, the registration acceptance message may be received as part of the registration procedure (e.g., U2X registration procedure) performed between the first UE 115-f and the network entity 105-b. In this regard, the first UE 115-f may receive (and the network entity 105-b may transmit) the registration acceptance message at 425 based on receiving/transmitting the control signaling at 405, transmitting/receiving the capability signaling at 410, retrieving the subscription data at 415, updating the UE context at 420, or any combination thereof.

The registration acceptance message may be transmitted/received in accordance with a subscription associated with the first UE 115-f with the network. In some aspects, the registration acceptance message may include an authorization an authorization for the first UE 115-f to perform the sidelink communications to support the one or more UAV services. In other words, the registration acceptance message may authorize the first UE 115-b to perform the UAV services (e.g., U2X communications, U2X services) indicated via the capability signaling.

At 430, the first UE 115-f may communicate (e.g., transmit, receive) a sidelink message associated with the one or more supported/authorized UAV services. In particular, the first UE 115-f may communicate the sidelink message (e.g., perform a U2X communication) for the UAV service in accordance with the capability of the UE first UE 115-f to perform the UAV services and the subscription associated with the first UE 115-f. As such, the first UE 115-f may communicate the sidelink message (e.g., perform a U2X communication) for a UAV service at 430 based on receiving the control signaling at 405, transmitting the capability signaling at 410, receiving the registration acceptance message at 425, or any combination thereof.

For example, in cases where the capability signaling indicates an AMBR or RAT associated with the capability of the first UE 115-f to perform the UAV services, the first UE 115-f may communicate the sidelink message at 430 (e.g., perform the UAV service, perform the U2X communication) in accordance with the indicated AMBR, the indicated RAT, or both. Similarly, in cases where the capability signaling indicates a BWP associated with the capability of the first UE 115-f to perform the UAV services, the first UE 115-f may communicate the sidelink message at 430 (e.g., perform the UAV service, perform the U2X communication) within the indicated BWP. Moreover, the first UE 115-f may perform the UAV services at 430 based on receiving an authorization to perform the U2X AV services via the registration acceptance message at 425.

At 435, the first UE 115-f may receive control signaling from the network entity 105-e, where the control signaling indicates a revocation of the authorization for the first UE 115-f to perform the UAV services. In other words, the control signaling at 435 may indicate that the first UE 115-f is no longer authorized to perform sidelink messages for the UAV services. As such, in some implementations, the first UE 115-f may refrain from performing UAV services (e.g., U2X communications) after receiving the revocation at 435.

Techniques described herein may enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

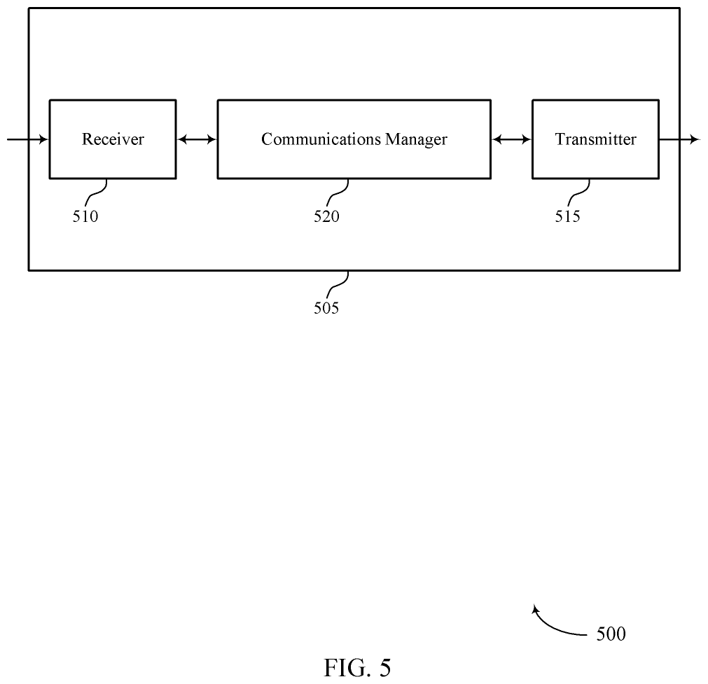

FIG. 5 shows a block diagram 500 of a device 505 that supports techniques for U2X subscription management in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for U2X subscription management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for U2X subscription management). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for U2X subscription management as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting, as part of a registration procedure between the UE and a network, capability signaling indicating an unmanned aerial vehicle (UAV)-related category associated with the UE and a capability for the UE to perform sidelink communications to support one or more UAV services. The communications manager 520 may be configured as or otherwise support a means for receiving, as part of the registration procedure and based on the capability signaling, a registration acceptance message in accordance with a subscription associated with the UE. The communications manager 520 may be configured as or otherwise support a means for communicating a sidelink message associated with the one or more UAV services in accordance with the capability of the UE to perform sidelink communications to support the one or more UAV services and the subscription associated with the UE.

By including or configuring the communications manager 520 in accordance with examples as described herein, the device 505 (e.g., a processor controlling or otherwise coupled with the receiver 510, the transmitter 515, the communications manager 520, or a combination thereof) may support techniques which enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

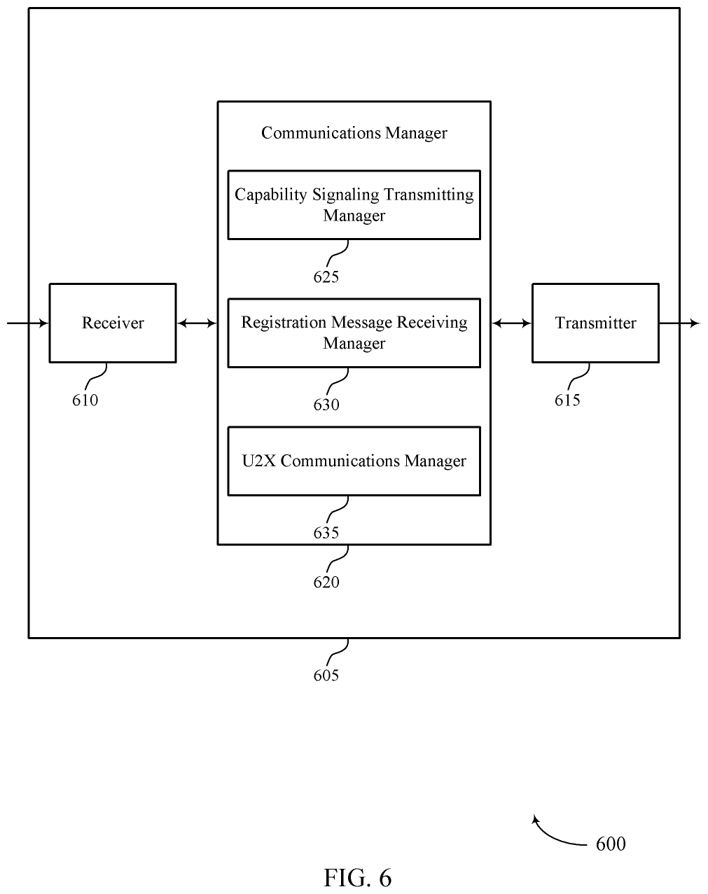

FIG. 6 shows a block diagram 600 of a device 605 that supports techniques for U2X subscription management in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for U2X subscription management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for U2X subscription management). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for U2X subscription management as described herein. For example, the communications manager 620 may include a capability signaling transmitting manager 625, a registration message receiving manager 630, a U2X communications manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The capability signaling transmitting manager 625 may be configured as or otherwise support a means for transmitting, as part of a registration procedure between the UE and a network, capability signaling indicating a UAV-related category associated with the UE and a capability for the UE to perform sidelink communications to support one or more UAV services. The registration message receiving manager 630 may be configured as or otherwise support a means for receiving, as part of the registration procedure and based on the capability signaling, a registration acceptance message in accordance with a subscription associated with the UE. The U2X communications manager 635 may be configured as or otherwise support a means for communicating a sidelink message associated with the one or more UAV services in accordance with the capability of the UE to perform sidelink communications to support the one or more UAV services and the subscription associated with the UE.

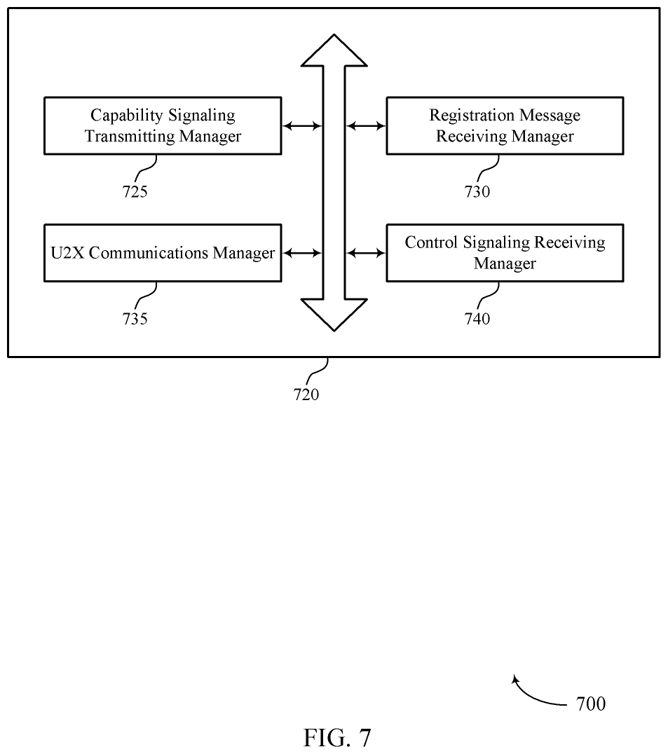

FIG. 7 shows a block diagram 700 of a communications manager 720 that supports techniques for U2X subscription management in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for U2X subscription management as described herein. For example, the communications manager 720 may include a capability signaling transmitting manager 725, a registration message receiving manager 730, a U2X communications manager 735, a control signaling receiving manager 740, or any combination thereof. Each of these components may communicate, directly or indirectly, with one another (e.g., via one or more buses).

The communications manager 720 may support wireless communication at a UE in accordance with examples as disclosed herein. The capability signaling transmitting manager 725 may be configured as or otherwise support a means for transmitting, as part of a registration procedure between the UE and a network, capability signaling indicating a UAV-related category associated with the UE and a capability for the UE to perform sidelink communications to support one or more UAV services. The registration message receiving manager 730 may be configured as or otherwise support a means for receiving, as part of the registration procedure and based on the capability signaling, a registration acceptance message in accordance with a subscription associated with the UE. The U2X communications manager 735 may be configured as or otherwise support a means for communicating a sidelink message associated with the one or more UAV services in accordance with the capability of the UE to perform sidelink communications to support the one or more UAV services and the subscription associated with the UE.

In some examples, the capability signaling transmitting manager 725 may be configured as or otherwise support a means for transmitting, via the capability signaling, an indication of an AMBR, a supported RAT, or both, associated with the capability to perform sidelink communications to support the one or more UAV services, where the sidelink message is communicated in accordance with the AMBR, the supported RAT, or both.

In some examples, the capability signaling transmitting manager 725 may be configured as or otherwise support a means for transmitting, via the capability signaling, an indication of a first AMBR associated with a first RAT and a second AMBR associated with a second RAT, where the sidelink message is communicated in accordance with the first AMBR and the first RAT or in accordance with the second AMBR and the second RAT, where the first RAT includes a 4G RAT, an LTE RAT, or both, and where the second RAT includes a 5G RAT, an NR RAT, or both.

In some examples, the capability signaling transmitting manager 725 may be configured as or otherwise support a means for transmitting, via the capability signaling, an indication of a bandwidth part associated with the capability to perform sidelink communications to support the one or more UAV services, where the sidelink message is communicated within the bandwidth part.

In some examples, the control signaling receiving manager 740 may be configured as or otherwise support a means for receiving control signaling indicating a set of multiple UAV services supported by the network, the set of multiple UAV services including the one or more UAV services, where transmitting the capability signaling is based on receiving the control signaling.

In some examples, the registration message receiving manager 730 may be configured as or otherwise support a means for receiving, via the registration acceptance message, an authorization for the UE to perform the sidelink communications to support the one or more UAV services, where communicating the sidelink message is based on the authorization.

In some examples, the control signaling receiving manager 740 may be configured as or otherwise support a means for receiving control signaling indicating a revocation of the authorization for the UE to perform the sidelink communications to support the one or more UAV services. In some examples, the U2X communications manager 735 may be configured as or otherwise support a means for refraining from performing the sidelink communications to support the one or more UAV services based on the revocation.

In some examples, the UAV-related category includes a UAV-C category, an authority UE, a stationary UE, or any combination thereof. In some examples, one or more UAV services include one or more U2X communications services.

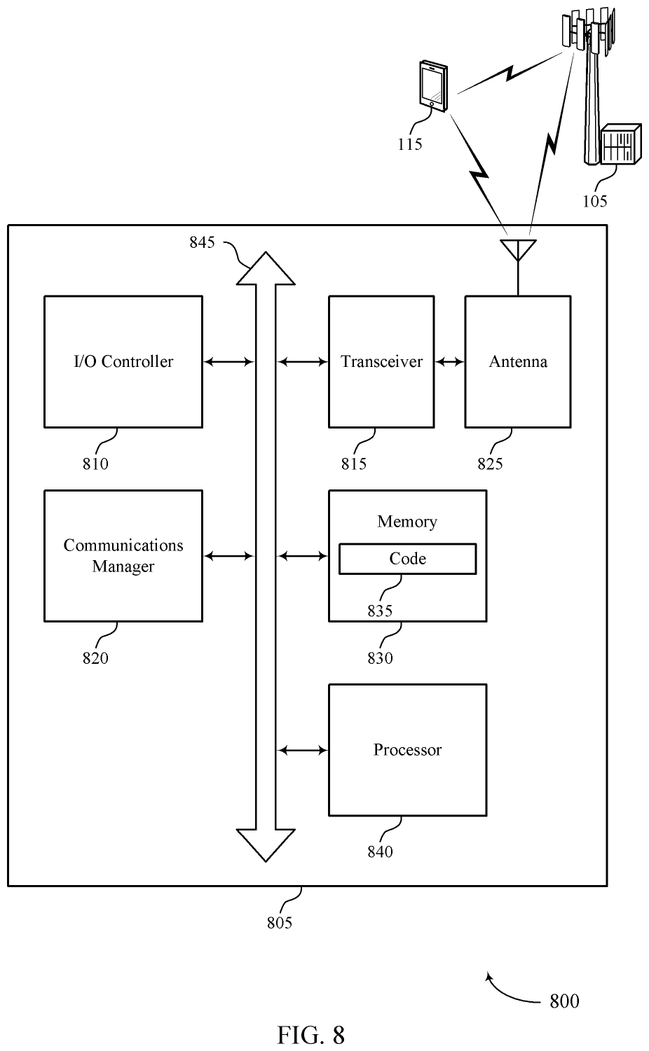

FIG. 8 shows a diagram of a system 800 including a device 805 that supports techniques for U2X subscription management in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for U2X subscription management). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting, as part of a registration procedure between the UE and a network, capability signaling indicating a UAV-related category associated with the UE and a capability for the UE to perform sidelink communications to support one or more UAV services. The communications manager 820 may be configured as or otherwise support a means for receiving, as part of the registration procedure and based on the capability signaling, a registration acceptance message in accordance with a subscription associated with the UE. The communications manager 820 may be configured as or otherwise support a means for communicating a sidelink message associated with the one or more UAV services in accordance with the capability of the UE to perform sidelink communications to support the one or more UAV services and the subscription associated with the UE.

By including or configuring the communications manager 820 in accordance with examples as described herein, the device 805 may support techniques which enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for U2X subscription management as described herein, or the processor 840 and the memory 830 may be otherwise configured to perform or support such operations.

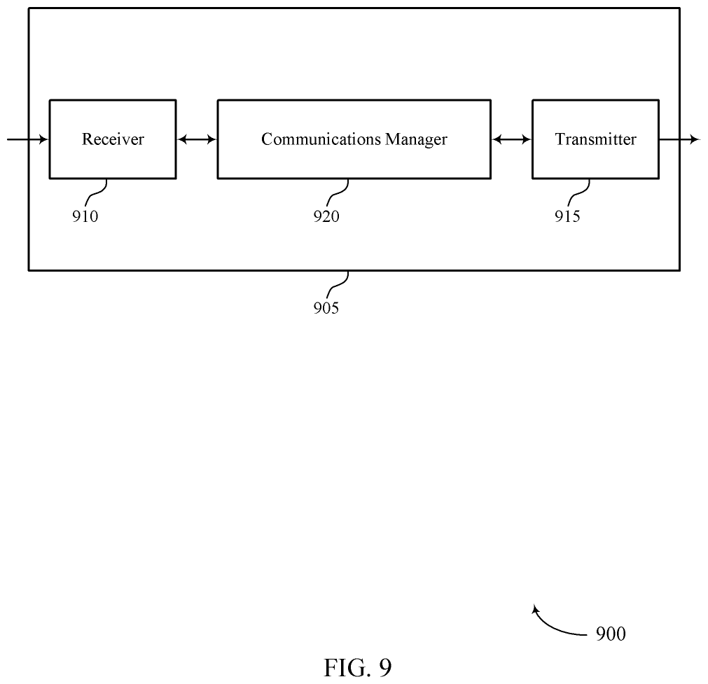

FIG. 9 shows a block diagram 900 of a device 905 that supports techniques for U2X subscription management in accordance with one or more aspects of the present disclosure. The device 905 may be an example of aspects of a Network Entity-ALPHA as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for U2X subscription management). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for U2X subscription management). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for U2X subscription management as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 may be configured as or otherwise support a means for receiving, from a UE as part of a registration procedure between the UE and a network, capability signaling indicating a UAV-related category associated with the UE and a capability for the UE to perform sidelink communications to support one or more UAV services. The communications manager 920 may be configured as or otherwise support a means for receiving, as part of the registration procedure and based on the capability signaling, subscription data associated with the UE, where the subscription data indicates an authorization for the UE to perform the sidelink communications to support the one or more UAV services. The communications manager 920 may be configured as or otherwise support a means for transmitting a registration acceptance message to the UE as part of the registration procedure and based on the subscription data, receiving the capability signaling, or both.

By including or configuring the communications manager 920 in accordance with examples as described herein, the device 905 (e.g., a processor controlling or otherwise coupled with the receiver 910, the transmitter 915, the communications manager 920, or a combination thereof) may support techniques which enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

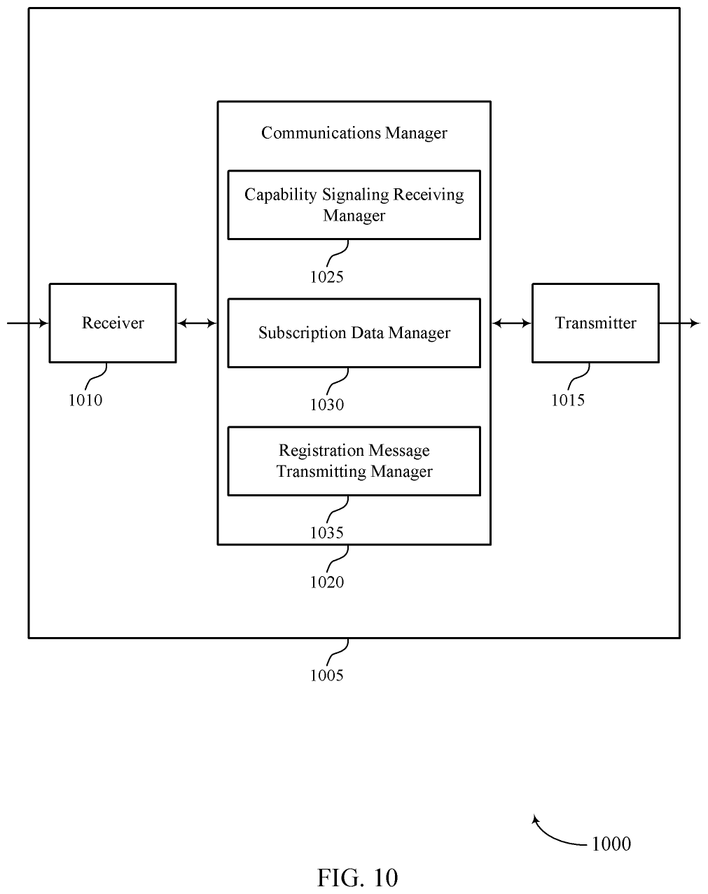

FIG. 10 shows a block diagram 1000 of a device 1005 that supports techniques for U2X subscription management in accordance with one or more aspects of the present disclosure. The device 1005 may be an example of aspects of a device 905 or a Network Entity-ALPHA 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for U2X subscription management). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for U2X subscription management). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for U2X subscription management as described herein. For example, the communications manager 1020 may include a capability signaling receiving manager 1025, a subscription data manager 1030, a registration message transmitting manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The capability signaling receiving manager 1025 may be configured as or otherwise support a means for receiving, from a UE as part of a registration procedure between the UE and a network, capability signaling indicating a UAV-related category associated with the UE and a capability for the UE to perform sidelink communications to support one or more UAV services. The subscription data manager 1030 may be configured as or otherwise support a means for receiving, as part of the registration procedure and based on the capability signaling, subscription data associated with the UE, where the subscription data indicates an authorization for the UE to perform the sidelink communications to support the one or more UAV services. The registration message transmitting manager 1035 may be configured as or otherwise support a means for transmitting a registration acceptance message to the UE as part of the registration procedure and based on the subscription data, receiving the capability signaling, or both.

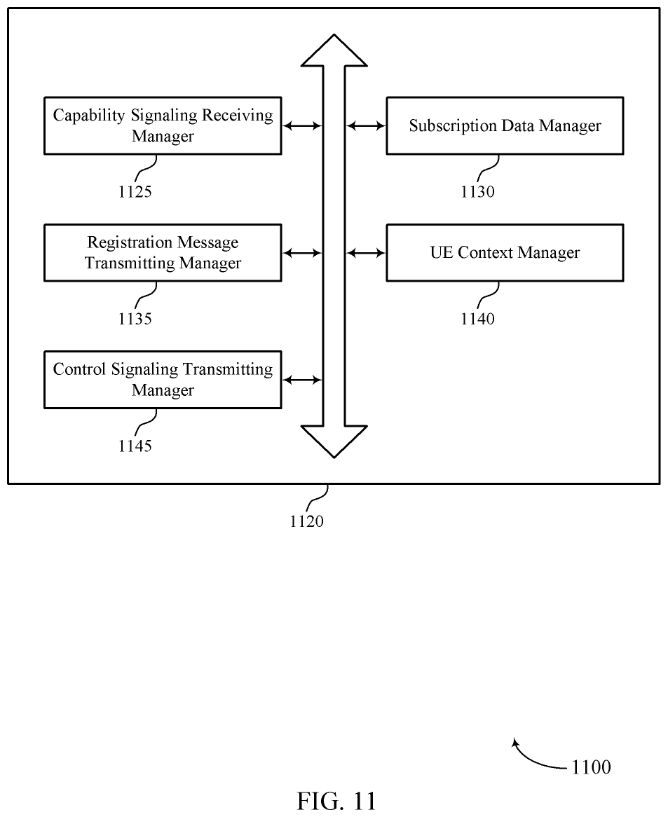

FIG. 11 shows a block diagram 1100 of a communications manager 1120 that supports techniques for U2X subscription management in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for U2X subscription management as described herein. For example, the communications manager 1120 may include a capability signaling receiving manager 1125, a subscription data manager 1130, a registration message transmitting manager 1135, a UE context manager 1140, a control signaling transmitting manager 1145, or any combination thereof. Each of these components may communicate, directly or indirectly, with one another (e.g., via one or more buses).

The communications manager 1120 may support wireless communication in accordance with examples as disclosed herein. The capability signaling receiving manager 1125 may be configured as or otherwise support a means for receiving, from a UE as part of a registration procedure between the UE and a network, capability signaling indicating a UAV-related category associated with the UE and a capability for the UE to perform sidelink communications to support one or more UAV services. The subscription data manager 1130 may be configured as or otherwise support a means for receiving, as part of the registration procedure and based on the capability signaling, subscription data associated with the UE, where the subscription data indicates an authorization for the UE to perform the sidelink communications to support the one or more UAV services. The registration message transmitting manager 1135 may be configured as or otherwise support a means for transmitting a registration acceptance message to the UE as part of the registration procedure and based on the subscription data, receiving the capability signaling, or both.

In some examples, to support receiving the subscription data, the subscription data manager 1130 may be configured as or otherwise support a means for retrieving the subscription data from a unified data management repository associated with the network.

In some examples, the subscription data associated with the UE includes U2X subscription data. In some examples, the U2X subscription data is associated with a SUPI associated with the UE.

In some examples, the UE context manager 1140 may be configured as or otherwise support a means for updating a UE context associated with the UE based on receiving the subscription data, where transmitting the registration acceptance message is based on updating the UE context.

In some examples, the capability signaling receiving manager 1125 may be configured as or otherwise support a means for receiving, via the capability signaling, an indication of an AMBR, a supported RAT, or both, associated with the capability to perform sidelink communications to support the one or more UAV services, where receiving the subscription data, transmitting the registration acceptance message, or both, is based on the AMBR, the supported RAT, or both.

In some examples, the capability signaling receiving manager 1125 may be configured as or otherwise support a means for receiving, via the capability signaling, an indication of a first AMBR associated with a first RAT and a second AMBR associated with a second RAT, where receiving the subscription data, transmitting the registration acceptance message, or both, is based on the first AMBR and the first RAT, the second AMBR and the second RAT, or both, where the first RAT includes a 4G RAT, an LTE RAT, or both, and where the second RAT includes a 5G RAT, an NR RAT, or both.

In some examples, the capability signaling receiving manager 1125 may be configured as or otherwise support a means for receiving, via the capability signaling, an indication of a bandwidth part associated with the capability to perform sidelink communications to support the one or more UAV services, where receiving the subscription data, transmitting the registration acceptance message, or both, is based on the bandwidth part.

In some examples, the control signaling transmitting manager 1145 may be configured as or otherwise support a means for transmitting control signaling indicating a set of multiple UAV services supported by the network, the set of multiple UAV services including the one or more UAV services, where receiving the capability signaling is based on transmitting the control signaling.

In some examples, the registration message transmitting manager 1135 may be configured as or otherwise support a means for transmitting, via the registration acceptance message and based on the subscription data, an indication of the authorization for the UE to perform the sidelink communications to support the one or more UAV services.

In some examples, the control signaling transmitting manager 1145 may be configured as or otherwise support a means for transmitting control signaling indicating a revocation of the authorization for the UE to perform the sidelink communications to support the one or more UAV services.

In some examples, the UAV-related category includes a UAV-C category, an authority UE, a stationary UE, or any combination thereof. In some examples, one or more UAV services include one or more U2X communications services.

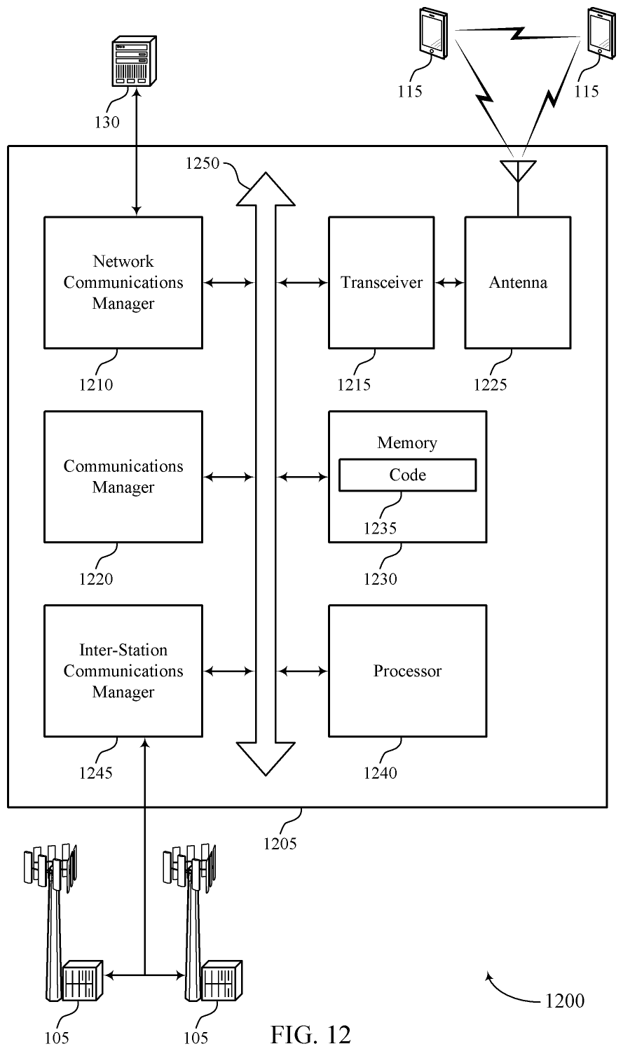

FIG. 12 shows a diagram of a system 1200 including a device 1205 that supports techniques for U2X subscription management in accordance with one or more aspects of the present disclosure. The device 1205 may be an example of or include the components of a device 905, a device 1005, or a Network Entity-ALPHA as described herein. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for U2X subscription management). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage

communications with other network entities 105, and may include a controller or scheduler for controlling communications with UEs 115 in cooperation with other network entities 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between network entities 105 (e.g., between components of base stations).

The communications manager 1220 may support wireless communication in accordance with examples as disclosed herein. For example, the communications manager 1220 may be configured as or otherwise support a means for receiving, from a UE as part of a registration procedure between the UE and a network, capability signaling indicating a UAV-related category associated with the UE and a capability for the UE to perform sidelink communications to support one or more UAV services. The communications manager 1220 may be configured as or otherwise support a means for receiving, as part of the registration procedure and based on the capability signaling, subscription data associated with the UE, where the subscription data indicates an authorization for the UE to perform the sidelink communications to support the one or more UAV services. The communications manager 1220 may be configured as or otherwise support a means for transmitting a registration acceptance message to the UE as part of the registration procedure and based on the subscription data, receiving the capability signaling, or both.

By including or configuring the communications manager 1220 in accordance with examples as described herein, the device 1205 may support techniques which enable registration procedures between UEs 115 (e.g., UAVs) and the network, and techniques for managing and updating U2X subscription information. In particular, techniques described herein enable UEs 115 to indicate a capability to perform various U2X communications (e.g., UAV services), and receive authorization to perform respective U2X communications. In this regard, techniques described herein support signaling between UEs 115 and the network which enables the network to register and update subscription data for the UEs 115 associated with U2X services, thereby enabling efficient and widespread use of U2X services.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for U2X subscription management as described herein, or the processor 1240 and the memory 1230 may be otherwise configured to perform or support such operations.

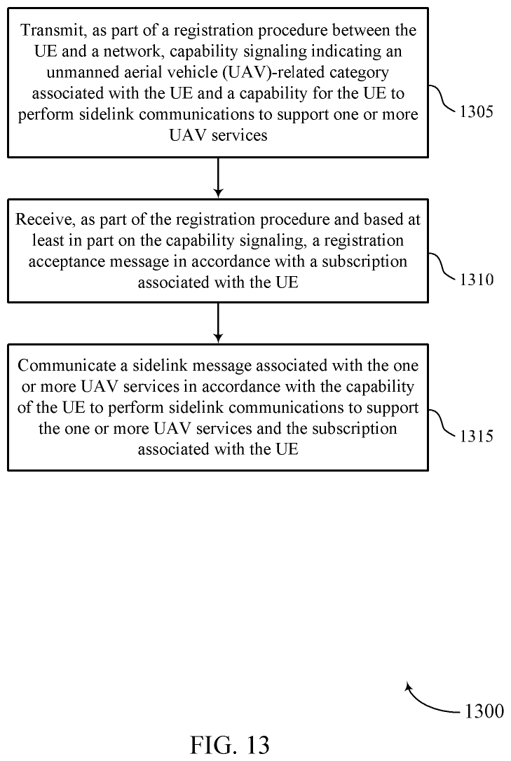

FIG. 13 shows a flowchart illustrating a method 1300 that supports techniques for U2X subscription management in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, as part of a registration procedure between the UE and a network, capability signaling indicating a UAV-related category associated with the UE and a capability for the UE to perform sidelink communications to support one or more UAV services. The operations of 1305 may be performed in accordance with examples as disclosed herein. In some examples, aspects of the operations of 1305 may be performed by a capability signaling transmitting manager 725 as described with reference to FIG. 7.

At 1310, the method may include receiving, as part of the registration procedure and based on the capability signaling, a registration acceptance message in accordance with a subscription associated with the UE. The operations of 1310 may be performed in accordance with examples as disclosed herein. In some examples, aspects of the operations of 1310 may be performed by a registration message receiving manager 730 as described with reference to FIG. 7.

At 1315, the method may include communicating a sidelink message associated with the one or more UAV services in accordance with the capability of the UE to perform sidelink communications to support the one or more UAV services and the subscription associated with the UE. The operations of 1315 may be performed in accordance with examples as disclosed herein. In some examples, aspects of the operations of 1315 may be performed by a U2X communications manager 735 as described with reference to FIG. 7.

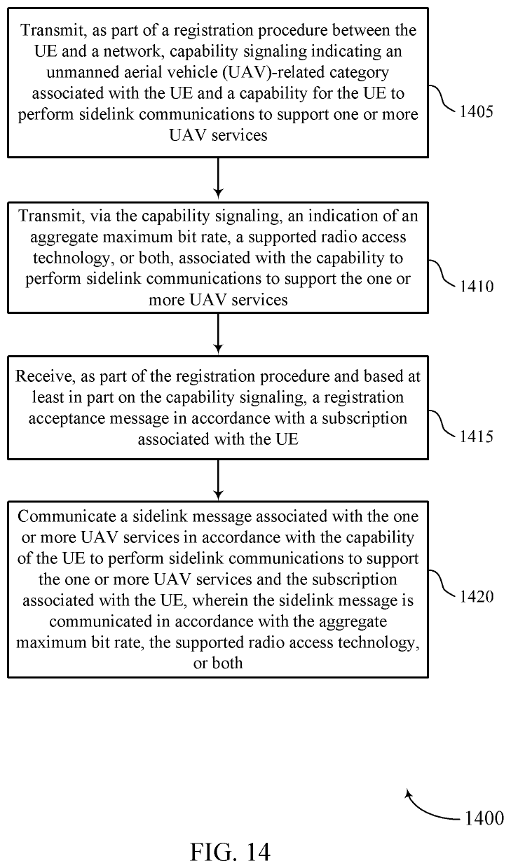

FIG. 14 shows a flowchart illustrating a method 1400 that supports techniques for U2X subscription management in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, as part of a registration procedure between the UE and a network, capability signaling indicating a UAV-related category associated with the UE and a capability for the UE to perform sidelink communications to support one or more UAV services. The operations of 1405 may be performed in accordance with examples as disclosed herein. In some examples, aspects of the operations of 1405 may be performed by a capability signaling transmitting manager 725 as described with reference to FIG. 7.

At 1410, the method may include transmitting, via the capability signaling, an indication of an AMBR, a supported RAT, or both, associated with the capability to perform sidelink communications to support the one or more UAV services. The operations of 1410 may be performed in accordance with examples as disclosed herein. In some examples, aspects of the operations of 1410 may be performed by a capability signaling transmitting manager 725 as described with reference to FIG. 7.

At 1415, the method may include receiving, as part of the registration procedure and based on the capability signaling, a registration acceptance message in accordance with a subscription associated with the UE. The operations of 1415 may be performed in accordance with examples as disclosed herein. In some examples, aspects of the operations of 1415 may be performed by a registration message receiving manager 730 as described with reference to FIG. 7.

At 1420, the method may include communicating a sidelink message associated with the one or more UAV services in accordance with the capability of the UE to perform sidelink communications to support the one or more UAV services and the subscription associated with the UE, where the sidelink message is communicated in accordance with the AMBR, the supported RAT, or both. The operations of 1420 may be performed in accordance with examples as disclosed herein. In some examples, aspects of the operations of 1420 may be performed by a U2X communications manager 735 as described with reference to FIG. 7.

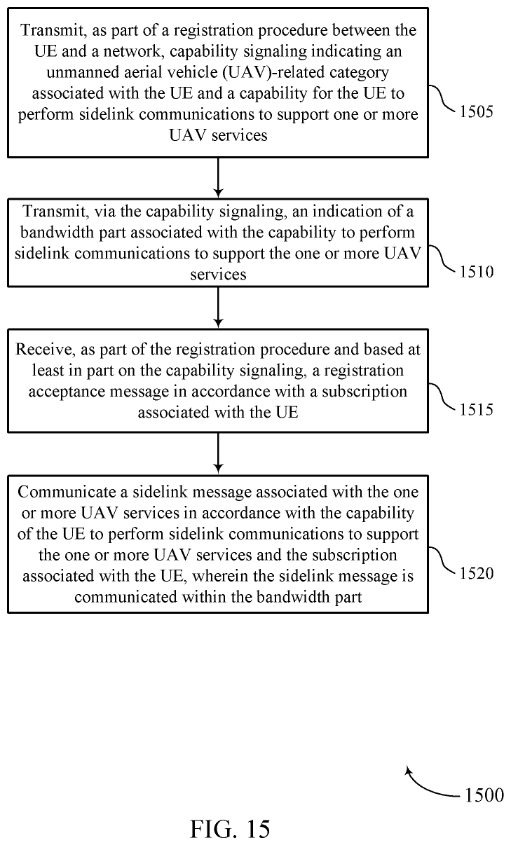

FIG. 15 shows a flowchart illustrating a method 1500 that supports techniques for U2X subscription management in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting, as part of a registration procedure between the UE and a network, capability signaling indicating a UAV-related category associated with the UE and a capability for the UE to perform sidelink communications to support one or more UAV services. The operations of 1505 may be performed in accordance with examples as disclosed herein. In some examples, aspects of the operations of 1505 may be performed by a capability signaling transmitting manager 725 as described with reference to FIG. 7.

At 1510, the method may include transmitting, via the capability signaling, an indication of a bandwidth part associated with the capability to perform sidelink communications to support the one or more UAV services. The operations of 1510 may be performed in accordance with examples as disclosed herein. In some examples, aspects of the operations of 1510 may be performed by a capability signaling transmitting manager 725 as described with reference to FIG. 7.

At 1515, the method may include receiving, as part of the registration procedure and based on the capability signaling, a registration acceptance message in accordance with a subscription associated with the UE. The operations of 1515 may be performed in accordance with examples as disclosed herein. In some examples, aspects of the operations of 1515 may be performed by a registration message receiving manager 730 as described with reference to FIG. 7.

At 1520, the method may include communicating a sidelink message associated with the one or more UAV services in accordance with the capability of the UE to perform sidelink communications to support the one or more UAV services and the subscription associated with the UE, where the sidelink message is communicated within the bandwidth part. The operations of 1520 may be performed in accordance with examples as disclosed herein. In some examples, aspects of the operations of 1520 may be performed by a U2X communications manager 735 as described with reference to FIG. 7.

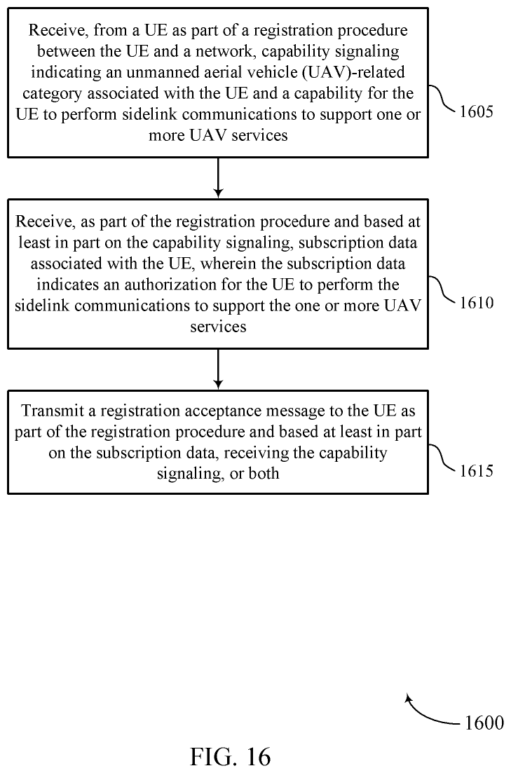

FIG. 16 shows a flowchart illustrating a method 1600 that supports techniques for U2X subscription management in accordance with one or more aspects of the present disclosure. The operations of the method 1600 may be implemented by a Network Entity-ALPHA or its components as described herein. For example, the operations of the method 1600 may be performed by a Network Entity-ALPHA as described with reference to FIGS. 1 through 4 and 9 through 12. In some examples, a Network Entity-ALPHA may execute a set of instructions to control the functional elements of the Network Entity-ALPHA to perform the described functions. Additionally, or alternatively, the Network Entity-ALPHA may perform aspects of the described functions using special-purpose hardware.

At 1605, the method may include receiving, from a UE as part of a registration procedure between the UE and a network, capability signaling indicating a UAV-related category associated with the UE and a capability for the UE to perform sidelink communications to support one or more UAV services. The operations of 1605 may be performed in accordance with examples as disclosed herein. In some examples, aspects of the operations of 1605 may be performed by a capability signaling receiving manager 1125 as described with reference to FIG. 11.

At 1610, the method may include receiving, as part of the registration procedure and based on the capability signaling, subscription data associated with the UE, where the subscription data indicates an authorization for the UE to perform the sidelink communications to support the one or more UAV services. The operations of 1610 may be performed in accordance with examples as disclosed herein. In some examples, aspects of the operations of 1610 may be performed by a subscription data manager 1130 as described with reference to FIG. 11.

At 1615, the method may include transmitting a registration acceptance message to the UE as part of the registration procedure and based on the subscription data, receiving the capability signaling, or both. The operations of 1615 may be performed in accordance with examples as disclosed herein. In some examples, aspects of the operations of 1615 may be performed by a registration message transmitting manager 1135 as described with reference to FIG. 11.

The following provides an overview of aspects of the present disclosure:

Aspect 1: A method for wireless communication at a UE, comprising: transmitting, as part of a registration procedure between the UE and a network, capability signaling indicating a UAV-related category associated with the UE and a capability for the UE to perform sidelink communications to support one or more UAV services; receiving, as part of the registration procedure and based at least in part on the capability signaling, a registration acceptance message in accordance with a subscription associated with the UE; and communicating a sidelink message associated with the one or more UAV services in accordance with the capability of the UE to perform sidelink communications to support the one or more UAV services and the subscription associated with the UE.

Aspect 2: The method of aspect 1, further comprising: transmitting, via the capability signaling, an indication of an AMBR, a supported RAT, or both, associated with the capability to perform sidelink communications to support the one or more UAV services, wherein the sidelink message is communicated in accordance with the AMBR, the supported RAT, or both.

Aspect 3: The method of aspect 2, further comprising: transmitting, via the capability signaling, an indication of a first AMBR associated with a first RAT and a second AMBR associated with a second RAT, wherein the sidelink message is communicated in accordance with the first AMBR and the first RAT or in accordance with the second AMBR and the second RAT, wherein the first RAT comprises a 4G RAT, an LTE RAT, or both, and wherein the second RAT comprises a 5G RAT, an NR RAT, or both.

Aspect 4: The method of any of aspects 1 through 3, further comprising: transmitting, via the capability signaling, an indication of a BWP associated with the capability to perform sidelink communications to support the one or more UAV services, wherein the sidelink message is communicated within the BWP.

Aspect 5: The method of any of aspects 1 through 4, further comprising: receiving control signaling indicating a plurality of UAV services supported by the network, the plurality of UAV services including the one or more UAV services, wherein transmitting the capability signaling is based at least in part on receiving the control signaling.

Aspect 6: The method of any of aspects 1 through 5, further comprising: receiving, via the registration acceptance message, an authorization for the UE to perform the sidelink communications to support the one or more UAV services, wherein communicating the sidelink message is based at least in part on the authorization.

Aspect 7: The method of aspect 6, further comprising: receiving control signaling indicating a revocation of the authorization for the UE to perform the sidelink communications to support the one or more UAV services; and refraining from performing the sidelink communications to support the one or more UAV services based at least in part on the revocation.

Aspect 8: The method of any of aspects 1 through 7, wherein the UAV-related category comprises a UAV-C category, an authority UE, a stationary UE, or any combination thereof.

Aspect 9: The method of any of aspects 1 through 8, wherein one or more UAV services comprise one or more U2X communications services.

Aspect 10: A method for wireless communication, comprising: receiving, from a UE as part of a registration procedure between the UE and a network, capability signaling indicating a UAV-related category associated with the UE and a capability for the UE to perform sidelink communications to support one or more UAV services; receiving, as part of the registration procedure and based at least in part on the capability signaling, subscription data associated with the UE, wherein the subscription data indicates an authorization for the UE to perform the sidelink communications to support the one or more UAV services; and transmitting a registration acceptance message to the UE as part of the registration procedure and based at least in part on the subscription data, receiving the capability signaling, or both.

Aspect 11: The method of aspect 10, wherein receiving the subscription data comprises: retrieving the subscription data from a unified data management repository associated with the network.

Aspect 12: The method of any of aspects 10 through 11, wherein the subscription data associated with the UE comprises U2X subscription data.

Aspect 13: The method of aspect 12, wherein the U2X subscription data is associated with a SUPI associated with the UE.

Aspect 14: The method of any of aspects 10 through 13, further comprising: updating a UE context associated with the UE based at least in part on receiving the subscription data, wherein transmitting the registration acceptance message is based at least in part on updating the UE context.

Aspect 15: The method of any of aspects 10 through 14, further comprising: receiving, via the capability signaling, an indication of an AMBR, a supported RAT, or both, associated with the capability to perform sidelink communications to support the one or more UAV services, wherein receiving the subscription data, transmitting the registration acceptance message, or both, is based at least in part on the AMBR, the supported RAT, or both.

Aspect 16: The method of aspect 15, further comprising: receiving, via the capability signaling, an indication of a first AMBR associated with a first RAT and a second AMBR associated with a second RAT, wherein receiving the subscription data, transmitting the registration acceptance message, or both, is based at least in part on the first AMBR and the first RAT, the second AMBR and the second RAT, or both, wherein the first RAT comprises a 4G RAT, an LTE RAT, or both, and wherein the second RAT comprises a 5G RAT, an NR RAT, or both.

Aspect 17: The method of any of aspects 10 through 16, further comprising: receiving, via the capability signaling, an indication of a BWP associated with the capability to perform sidelink communications to support the one or more UAV services, wherein receiving the subscription data, transmitting the registration acceptance message, or both, is based at least in part on the BWP.

Aspect 18: The method of any of aspects 10 through 17, further comprising: transmitting control signaling indicating a plurality of UAV services supported by the network, the plurality of UAV services including the one or more UAV services, wherein receiving the capability signaling is based at least in part on transmitting the control signaling.

Aspect 19: The method of any of aspects 10 through 18, further comprising: transmitting, via the registration acceptance message and based at least in part on the subscription data, an indication of the authorization for the UE to perform the sidelink communications to support the one or more UAV services.

Aspect 20: The method of aspect 19, further comprising: transmitting control signaling indicating a revocation of the authorization for the UE to perform the sidelink communications to support the one or more UAV services.

Aspect 21: The method of any of aspects 10 through 20, wherein the UAV-related category comprises a UAV-C category, an authority UE, a stationary UE, or any combination thereof.

Aspect 22: The method of any of aspects 10 through 21, wherein one or more UAV services comprise one or more U2X communications services.

Aspect 23: An apparatus for wireless communication at a UE, comprising a processor; memory coupled with the processor; and instructions stored in the memory and executable by the processor to cause the apparatus to perform a method of any of aspects 1 through 9.

Aspect 24: An apparatus for wireless communication at a UE, comprising at least one means for performing a method of any of aspects 1 through 9.

Aspect 25: A non-transitory computer-readable medium storing code for wireless communication at a UE, the code comprising instructions executable by a processor to perform a method of any of aspects 1 through 9.

Aspect 26: An apparatus for wireless communication, comprising a processor; memory coupled with the processor; and instructions stored in the memory and executable by the processor to cause the apparatus to perform a method of any of aspects 10 through 22.

Aspect 27: An apparatus for wireless communication, comprising at least one means for performing a method of any of aspects 10 through 22.

Aspect 28: A non-transitory computer-readable medium storing code for wireless communication, the code comprising instructions executable by a processor to perform a method of any of aspects 10 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
transmit, as part of a registration procedure between the UE and a network, capability signaling indicating an unmanned aerial vehicle (UAV)-related category associated with the UE and a capability for the UE to perform sidelink communications to support one or more UAV services:
receive, as part of the registration procedure and based at least in part on the capability signaling, a registration acceptance message in accordance with a subscription associated with the UE; and
communicate a sidelink message associated with the one or more UAV services in accordance with the capability of the UE to perform sidelink communications to support the one or more UAV services and the subscription associated with the UE.

2. The apparatus of claim 1, wherein the instructions are further executable by the processor to cause the apparatus to:
transmit, via the capability signaling, an indication of an aggregate maximum bit rate, a supported radio access technology, or both, associated with the capability to perform sidelink communications to support the one or more UAV services, wherein the sidelink message is communicated in accordance with the aggregate maximum bit rate, the supported radio access technology, or both.

3. The apparatus of claim 2, wherein the instructions are further executable by the processor to cause the apparatus to:
transmit, via the capability signaling, an indication of a first aggregate maximum bit rate associated with a first radio access technology and a second aggregate maximum bit rate associated with a second radio access technology, wherein the sidelink message is communicated in accordance with the first aggregate maximum bit rate and the first radio access technology or in accordance with the second aggregate maximum bit rate and the second radio access technology, wherein the first radio access technology comprises a Fourth Generation radio access technology, a Long-Term Evolution radio access technology, or both, and wherein the second radio access technology comprises a Fifth Generation radio access technology, a New Radio access technology, or both.

4. The apparatus of claim 1, wherein the instructions are further executable by the processor to cause the apparatus to:
transmit, via the capability signaling, an indication of a bandwidth part associated with the capability to perform sidelink communications to support the one or more UAV services, wherein the sidelink message is communicated within the bandwidth part.

5. The apparatus of claim 1, wherein the instructions are further executable by the processor to cause the apparatus to:
receive control signaling indicating a plurality of UAV services supported by the network, the plurality of UAV services including the one or more UAV services, wherein transmitting the capability signaling is based at least in part on receiving the control signaling.

6. The apparatus of claim 1, wherein the instructions are further executable by the processor to cause the apparatus to:
receive, via the registration acceptance message, an authorization for the UE to perform the sidelink communications to support the one or more UAV services, wherein communicating the sidelink message is based at least in part on the authorization.

7. The apparatus of claim 6, wherein the instructions are further executable by the processor to cause the apparatus to:
receive control signaling indicating a revocation of the authorization for the UE to perform the sidelink communications to support the one or more UAV services; and
refrain from performing the sidelink communications to support the one or more UAV services based at least in part on the revocation.

8. The apparatus of claim 1, wherein the UAV-related category comprises a UAV-controller (UAV-C) category, an authority UE, a stationary UE, or any combination thereof.

9. The apparatus of claim 1, wherein one or more UAV services comprise one or more UAV-to-everything communications services.

10. An apparatus for wireless communication, comprising:
a processor;
memory coupled with the processor; and
instructions stored in the memory and executable by the processor to cause the apparatus to:
receive, from a user equipment (UE) as part of a registration procedure between the UE and a network, capability signaling indicating an unmanned aerial vehicle (UAV)-related category associated with the UE and a capability for the UE to perform sidelink communications to support one or more UAV services;
receive, as part of the registration procedure and based at least in part on the capability signaling, subscription data associated with the UE, wherein the subscription data indicates an authorization for the UE to perform the sidelink communications to support the one or more UAV services; and
transmit a registration acceptance message to the UE as part of the registration procedure and based at least in part on the subscription data, receiving the capability signaling, or both.

11. The apparatus of claim 10, wherein the instructions to receive the subscription data are executable by the processor to cause the apparatus to:
retrieve the subscription data from a unified data management repository associated with the network.

12. The apparatus of claim 10, wherein the subscription data associated with the UE comprises UAV-to-everything subscription data.

13. The apparatus of claim 12, wherein the UAV-to-everything subscription data is associated with a subscription permanent identifier (SUPI) associated with the UE.

14. The apparatus of claim 10, wherein the instructions are further executable by the processor to cause the apparatus to:
update a UE context associated with the UE based at least in part on receiving the subscription data, wherein transmitting the registration acceptance message is based at least in part on updating the UE context.

15. The apparatus of claim 10, wherein the instructions are further executable by the processor to cause the apparatus to:
receive, via the capability signaling, an indication of an aggregate maximum bit rate, a supported radio access technology, or both, associated with the capability to perform sidelink communications to support the one or more UAV services, wherein receiving the subscription data, transmitting the registration acceptance message, or both, is based at least in part on the aggregate maximum bit rate, the supported radio access technology, or both.

16. The apparatus of claim 15, wherein the instructions are further executable by the processor to cause the apparatus to:
receive, via the capability signaling, an indication of a first aggregate maximum bit rate associated with a first radio access technology and a second aggregate maximum bit rate associated with a second radio access technology, wherein receiving the subscription data, transmitting the registration acceptance message, or both, is based at least in part on the first aggregate maximum bit rate and the first radio access technology, the second aggregate maximum bit rate and the second radio access technology, or both, wherein the first radio access technology comprises a Fourth Generation radio access technology, a Long-Term Evolution radio access technology, or both, and wherein the second radio access technology comprises a Fifth Generation radio access technology, a New Radio access technology, or both.

17. The apparatus of claim 10, wherein the instructions are further executable by the processor to cause the apparatus to:
receive, via the capability signaling, an indication of a bandwidth part associated with the capability to perform sidelink communications to support the one or more UAV services, wherein receiving the subscription data, transmitting the registration acceptance message, or both, is based at least in part on the bandwidth part.

18. The apparatus of claim 10, wherein the instructions are further executable by the processor to cause the apparatus to:
transmit control signaling indicating a plurality of UAV services supported by the network, the plurality of UAV services including the one or more UAV services, wherein receiving the capability signaling is based at least in part on transmitting the control signaling.

19. The apparatus of claim 10, wherein the instructions are further executable by the processor to cause the apparatus to:
transmit, via the registration acceptance message and based at least in part on the subscription data, an indication of the authorization for the UE to perform the sidelink communications to support the one or more UAV services.

20. The apparatus of claim 19, wherein the instructions are further executable by the processor to cause the apparatus to:
transmit control signaling indicating a revocation of the authorization for the UE to perform the sidelink communications to support the one or more UAV services.

21. The apparatus of claim 10, wherein the UAV-related category comprises a UAV-controller (UAV-C) category, an authority UE, a stationary UE, or any combination thereof.

22. The apparatus of claim 10, wherein one or more UAV services comprise one or more UAV-to-everything communications services.

23. A method for wireless communication at a user equipment (UE), comprising:
transmitting, as part of a registration procedure between the UE and a network, capability signaling indicating an unmanned aerial vehicle (UAV)-related category associated with the UE and a capability for the UE to perform sidelink communications to support one or more UAV services;
receiving, as part of the registration procedure and based at least in part on the capability signaling, a registration acceptance message in accordance with a subscription associated with the UE; and
communicating a sidelink message associated with the one or more UAV services in accordance with the capability of the UE to perform sidelink communications to support the one or more UAV services and the subscription associated with the UE.

24. The method of claim 23, further comprising:
transmitting, via the capability signaling, an indication of an aggregate maximum bit rate, a supported radio access technology, or both, associated with the capability to perform sidelink communications to support the one or more UAV services, wherein the sidelink message is communicated in accordance with the aggregate maximum bit rate, the supported radio access technology, or both.

25. The method of claim 24, further comprising:
transmitting, via the capability signaling, an indication of a first aggregate maximum bit rate associated with a first radio access technology and a second aggregate maximum bit rate associated with a second radio access technology, wherein the sidelink message is communicated in accordance with the first aggregate maximum bit rate and the first radio access technology or in accordance with the second aggregate maximum bit rate and the second radio access technology, wherein the first radio access technology comprises a Fourth Generation radio access technology, a Long-Term Evolution radio access technology, or both, and wherein the second radio access technology comprises a Fifth Generation radio access technology, a New Radio access technology, or both.

26. The method of claim 23, further comprising:
transmitting, via the capability signaling, an indication of a bandwidth part associated with the capability to perform sidelink communications to support the one or more UAV services, wherein the sidelink message is communicated within the bandwidth part.

27. The method of claim 23, further comprising:
receiving control signaling indicating a plurality of UAV services supported by the network, the plurality of UAV services including the one or more UAV services, wherein transmitting the capability signaling is based at least in part on receiving the control signaling.

28. The method of claim 23, further comprising:
receiving, via the registration acceptance message, an authorization for the UE to perform the sidelink communications to support the one or more UAV services, wherein communicating the sidelink message is based at least in part on the authorization.

29. A method for wireless communication, comprising:
receiving, from a user equipment (UE) as part of a registration procedure between the UE and a network, capability signaling indicating an unmanned aerial vehicle (UAV)-related category associated with the UE and a capability for the UE to perform sidelink communications to support one or more UAV services;
receiving, as part of the registration procedure and based at least in part on the capability signaling, subscription data associated with the UE, wherein the subscription data indicates an authorization for the UE to perform the sidelink communications to support the one or more UAV services; and
transmitting a registration acceptance message to the UE as part of the registration procedure and based at least in part on the subscription data, receiving the capability signaling, or both.

30. The method of claim 29, wherein receiving the subscription data comprises:
retrieving the subscription data from a unified data management repository associated with the network.
